(19) United States
(12) Patent Application Publication
(10) Pub. No.: US 2015/0220693 A1
(43) Pub. Date: Aug. 6, 2015

(54) DISEASE PROGRESSION PARAMETERS AND USES THEREOF FOR EVALUATING MULTIPLE SCLEROSIS

(71) Applicant: BIOGEN IDEC MA INC., Cambridge, MA (US)

(72) Inventors: Diego Cadavid, Concord, MA (US); Deborah Ann Kinch, Bedford, MA (US); Sophia Lee, Waltham, MA (US); Lei Xu, Wayland, MA (US)

(73) Assignee: BIOGEN IDEC MA INC., Cambridge, MA (US)

(21) Appl. No.: 14/421,561

(22) PCT Filed: Aug. 8, 2013
(86) PCT No.: PCT/US2013/054128

§ 371 Date: Feb. 13, 2015

Related U.S. Application Data
(60) Provisional application No. 61/682,521, filed on Aug. 13, 2012.

(51) Int. Cl. G06F 19/00

(52) U.S. Cl. CPC G06F 19/345

(57) ABSTRACT

Methods, systems and kits to detect and/or quantify disease progression in a subject having a progressive form of MS are disclosed.

### RELATED APPLICATIONS

This application claims the benefit of U.S. Provisional Application No. 61/682,521, filed Aug. 13, 2012, the contents of which are incorporated herein by reference in their entirety.

### BACKGROUND OF THE INVENTION

Multiple sclerosis (MS) is an inflammatory disease of the brain and spinal cord characterized by recurrent foci of inflammation that lead to destruction of the myelin sheath. In many areas, nerve fibers are also damaged. Inflammatory activity in MS patients tends to be highest in the initial phase of disease.

Emerging data demonstrate that irreversible axonal loss occurs early in the course of MS. Transected axons fail to regenerate in the central nervous system (CNS) and therefore, early treatment aimed at suppressing MS lesion formation is of paramount importance. As early as disease onset, axons are transected in lesions with active inflammation (Trapp et al. (1998) N Engl J Med 338: 278-285; Bjartmar et al. (2001) Curr Opin Neurol 14: 271-278; Ferguson et al. (1997) Brain 120: 393-399). The degree of demyelination is related to the degree of inflammation and the exposure of demyelinated axons to the inflammatory environment, as well as non-inflammatory mediators (Trapp et al. (1998) N Engl J Med 338: 278-285; Kornek et al. (2000) Am J Pathol 157: 267-276; Bitsch et al. (2000) Brain 123: 1174-1183). There is also destruction of oligodendrocytes with impaired remyelination in demyelinating lesions (Peterson et al. (2002) J Neuropathol Exp Neurol 61: 539-546; Chang et al. (2002) N Engl J Med 346: 165-173). The loss of oligodendrocytes leads to a reduction in the capacity to re-myelinate and may result in the loss of trophic factors that support neurons and axons (Bjartmar et al. (1999) J Neurocytol 28: 383-395).

MS mediated damage to the brain and spinal cord causes both physical and cognitive disabilities. The Expanded Disability Status Scale (EDSS) is a widely-used measure of disability in MS, and has traditionally been used as a primary endpoint to support registration of drugs for relapsing forms of the disease. However, the EDSS alone is typically insufficient to investigate therapeutic efficacy in progressive forms of MS due to, at least, its limited sensitivity in the higher EDSS range where it measures mostly long distance ambulation; a lack of responsiveness to worsening in non-ambulatory functions; and problems inherent to the EDSS scale due to, e.g., random variation, lack of linearity, and measurement errors. Thus, there is a need for additional clinical measures that supplement the sensitivity of the EDSS as an endpoint in order to adequately characterize treatment effects in MS, and more particularly, in progressive forms of MS.

### SUMMARY OF THE INVENTION

The present invention provides, at least in part, methods, systems and kits for the identification, assessment and/or treatment of a subject having a neurological disorder such as multiple sclerosis (MS), e.g., a progressive form of MS. In one embodiment, the methods, systems and kits include the step of detecting and/or quantifying sustained disease progression (or improvement) in the subject (e.g., a subject with primary or secondary progressive multiple sclerosis (PPMS or SPMS, respectively), or a subject with progressive-relapsing MS (PRMS), by acquiring a value of disease status or progression (also referred to individually herein as “disease status value” or “disease progression value,” respectively, or collectively as “disease status or progression value”). In one embodiment, the disease status or progression value includes a measure of one or more of upper extremity function, lower extremity function, and/or ambulatory function (e.g., short and/or longer distance ambulatory function). The disease status or progression value can further include other MS evaluating methodologies, such as the Expanded Disability Status Scale (EDSS). Scoring systems for facilitating data collection and calculation of assessment values, e.g., for an EDSS score, are also disclosed. Thus, the methods, systems and kits disclosed herein provide several advantages over existing methodologies, including, but not limited to, increased sensitivity in the higher EDSS range; increased responsiveness to worsening in non-long distance ambulatory functions; automated execution of scoring methodologies; improved scoring accuracy and consistency; and decreased problems inherent to the EDSS scale due to, e.g., random variation, lack of linearity, measurement errors, and interpretation errors in scoring.

Therefore, the invention can be used, for example, for one or more of: (i) diagnosing, prognosing and/or evaluating, a subject (e.g., a subject having a neurological disorder such as MS, e.g., a progressive form of MS); (ii) evaluating responsiveness to, or monitoring, a therapy (e.g., an MS therapy); (iii) identifying a subject as being stable, showing improvement or showing disease progression; (iv) to stratify a subject (e.g., an MS patient or patient population) as being a sustained disease non-progressor or a sustained disease progressor; (v) characterizing progressive form of MS; and/or (vi) more effectively monitoring, treating MS, or preventing the onset or worsening of disease progression and/or relapses.

Accordingly, in one aspect, the invention features a method of evaluating a subject (e.g., a patient, a patient group or a patient population), having multiple sclerosis (MS), or at risk of developing MS. In certain embodiments, the subject has a progressive form of MS (e.g., the subject has primary or secondary progressive multiple sclerosis (PPMS or SPMS, respectively), or the subject has progressive-relapsing MS (PRMS). The method includes acquiring a value of disease status or progression (e.g., a value of disease status or progression comprising a measure of one or more of: upper extremity function, lower extremity function, and/or a measure of ambulatory function), thereby evaluating the subject. In some embodiments, the disease status or progression value includes a measure of an ambulatory function other than the Expanded Disability Status Scale (EDSS). In one embodiment, the disease status or progression value includes a measure of short and/or longer distance ambulatory function. Alternatively, or in combination, the disease progression value includes a measure of upper and/or lower extremity function. The value of disease status or progression can further include an evaluation of the subject's status on the EDSS. In certain embodiments, disease progression in an MS subject includes a steady worsening of symptoms and/or disability over time. It shall be understood that evaluation of disease progression includes an assessment of worsening, stability or improvement of one or more symptoms and/or disability in the subject.

In a related aspect, the invention features a method of evaluating or monitoring progression of a disability in a subject (e.g., a patient, a patient group or a patient population) having multiple sclerosis (MS), or at risk of developing MS. In certain embodiments, the subject has a progressive form of MS (e.g., the subject has primary or secondary progressive multiple sclerosis (PPMS or SPMS, respectively), or the subject has progressive-relapsing MS (PRMS)). The method includes acquiring a value of disease status or progression (e.g., a value of disease status or progression comprising a measure of one or more of: upper extremity function, lower extremity function, and/or a measure of ambulatory function, thereby evaluating or monitoring progression of the disability in the subject. In some embodiments, the disease status or progression value includes a measure of an ambulatory function other than the EDSS. In one embodiment, the disease status or progression value includes a measure of short and/or longer distance ambulatory function. Alternatively, or in combination, the disease status or progression value includes a measure of upper and/or lower extremity function. The value of disease status or progression can further include an evaluation of the subject's status on the EDSS. In certain embodiments, disease progression in an MS subject includes a steady worsening of symptoms and/or disability over time. It shall be understood that evaluation or monitoring of disease progression includes an assessment of worsening, stability or improvement of one or more symptoms and/or disability in the subject.

In another related aspect, the invention features a method of evaluating or monitoring the effectiveness of a therapy in a subject (e.g., a patient, a patient group or a patient population), having MS, or at risk of developing MS. In certain embodiments, the subject has a progressive form of MS (e.g., the subject has primary or secondary progressive multiple sclerosis (PPMS or SPMS, respectively), or the subject has progressive-relapsing MS (PRMS)). The method includes acquiring a value of disease status or progression (e.g., a value of disease status or progression comprising a measure of one or more of: upper extremity function, lower extremity function, and/or a measure of ambulatory function), thereby evaluating or monitoring the effectiveness of the therapy in the subject. In some embodiments, the disease status or progression value includes a measure of an ambulatory function other than the EDSS. In one embodiment, the disease status or progression value includes a measure of short and/or longer distance ambulatory function. Alternatively, or in combination, the disease status or progression value includes a measure of upper and/or lower extremity function. The value of disease status or progression can further include an evaluation of the subject's status on the EDSS. In certain embodiments, disease progression in an MS subject includes a steady worsening of symptoms and/or disability over time. It shall be understood that evaluation or monitoring of disease progression includes an assessment of worsening, stability or improvement of one or more symptoms and/or disability in the subject.

In other embodiments, any of the aforesaid methods further include treating, or preventing in, a subject having MS one or more symptoms associated with MS. In certain embodiments, the treatment includes reducing, retarding, or preventing, a relapse, or the worsening of a disability, or the onset of sustained disease progression, in the MS subject. In one embodiment, the method includes, responsive to the value of disease status or progression, administering to the subject a therapy for MS (also referred to herein as an “MS therapy” or “MS treatment”), in an amount sufficient to reduce one or more symptoms associated with MS.

In another aspect, the invention features a method of treating or preventing MS (e.g., MS progression) in a subject (e.g., a patient, a patient group or a patient population) having MS, or at risk of developing MS. In certain embodiments, the subject has a progressive form of MS (e.g., the subject has primary or secondary progressive multiple sclerosis (PPMS or SPMS, respectively), or the subject has progressive-relapsing MS (PRMS). The method includes acquiring a value of disease status or progression (e.g., a value of disease status or progression comprising a measure of one or more of: upper extremity function, lower extremity function, and/or a measure of ambulatory function, e.g., short and/or longer distance ambulatory function), and

responsive to a determination of the value of disease status or progression, performing one, two or more of:

identifying the subject's progression status (e.g., identifying the subject as a progressor or non-progressor of disability);

administering an MS therapy;

selecting or altering a dosing of an MS therapy;

selecting or altering the schedule or time course of an MS therapy; or

selecting an alternative MS therapy,

thereby treating or preventing MS (e.g., MS progression) in the subject. In some embodiments, the disease status or progression value includes a measure of an ambulatory function other than the EDSS. In one embodiment, the disease status or progression value includes a measure of short and/or longer distance ambulatory function. Alternatively, or in combination, the disease status or progression value includes a measure of upper and/or lower extremity function. The value of disease status or progression can further include an evaluation of the subject's status on the EDSS. In certain embodiments, disease progression in an MS subject includes a steady worsening of symptoms and/or disability over time.

Additional embodiments or features of any of the foregoing methods are as follows:

In some embodiments, responsive to a determination of disease status or progression value using any of the aforesaid methods, the method further includes one or more of the following:

(i) identifying the subject as being in need of a therapy, e.g., an MS therapy (e.g., a first MS therapy, a second or subsequent (alternative) MS therapy);

(ii) identifying the subject as having an increased or a decreased response to a therapy, e.g., an MS therapy (e.g., a first MS therapy or a second (alternative) MS therapy);

(iii) evaluating a progressor's status (e.g., identifying the subject as being stable or showing an improvement in one or more abilities or function (e.g., as being a disease non-progressor), or showing a decline in one or more abilities or function (e.g., as being a disease progressor));

(iv) diagnosing and/or prognosing the subject;

(v) determining a therapy (e.g., an MS therapy), e.g., selecting or altering the course of a therapy or treatment, a dose, a treatment schedule or time course, and/or the use of an alternative MS therapy;

(vi) determining disease progression (e.g., MS disease progression) in the subject;

(vii) administering a therapy, e.g., an MS therapy (e.g., a first MS therapy or a second (alternative) MS therapy) to the subject; and/or

(viii) evaluating the effectiveness of a therapy in treating or preventing the onset of a progressive form of MS (e.g., evaluating the effectiveness of a therapy in treating or preventing an MS patient with primary or secondary progressive multiple sclerosis (PPMS or SPMS, respectively), or an MS patient with progressive-relapsing MS (PRMS).

In one embodiment, one or more of (i)-(viii) are carried out in response to the disease status or progression value. A change (e.g., an increased or a decrease) in the disease progression value relative to a specified or reference value indicates one or more of: identifies the subject as being in need of the therapy (e.g., an MS therapy (e.g., a first MS therapy, or a second or alternative MS therapy); identifies the subject as having an increased or decreased response to the therapy; determines the treatment to be used; and/or determines or predicts the time course of the disease (e.g., the progression of MS disease).

### Value of Disease Status or Progression

In one embodiment, an increase in the disease status or progression value, relative to a specified or reference value (e.g., a baseline or prior value for the subject, or an average or median value for a patient population), is indicative of disease progression, e.g., a steady worsening of symptoms and/or disability (or sustained disease progression), in the subject. In one embodiment, the specified or reference value is a value, e.g., a norm value, from a general population matched by one, two or all of age, sex and/or level of education.

In one embodiment, a decrease in the disease status or progression value, relative a specified or reference value (e.g., a baseline or prior value for the subject, or an average or median value for a patient population), is indicative of an improved outcome (e.g., a decrease in disease progression), in the subject. In one embodiment, the specified or reference value is a value, e.g., a norm value, from a general population matched by one, two or all of age, sex and/or level of education.

In one embodiment, the disease status or progression value is obtained by one or more (or all) of:

(i) an assessment of neurological function; or

(ii) an assessment of physical function. For example, an assessment of physical function can include an assessment of ambulatory function (e.g., short distance and/or longer distance ambulatory function), alone or in combination with an assessment of upper and/or lower extremity function.

In one embodiment, a disease status or progression value is acquired by evaluating one, two, three or more clinical impairment factors. Exemplary tests for evaluating clinical impairment factors include, but are not limited to, tests for evaluating neurological and/or ambulatory function (e.g., EDSS), tests for evaluating lower extremity ambulatory function and/or short distance ambulatory function (e.g., Timed Walk of 25 Feet (T25FW)), tests for evaluating longer distance ambulatory function (e.g., a timed (e.g., 5- or 6-minute) walk test (e.g., 6MWT)), or tests for evaluating upper extremity function (e.g., 9 Hole Peg Test (9HP test)).

In certain embodiments of the aforesaid methods, a change in the value of disease status or progression by at least 10%, 15%, 20%, 25% or higher in a measure of one or more of upper extremity function, lower extremity function, and/or ambulatory function other than EDSS (e.g., short and/or longer distance ambulatory function) is detected. In certain embodiments:

An increase in the value of disease status or progression of at least 10%, 15%, 20%, 25% or more in one, two or all of the aforesaid measures as described above is indicative of disease progression, e.g., a steady worsening of symptoms and/or disability in the subject; and

a decrease in the value of disease status or progression of at least 10%, 15%, 20%, 25% or more in one, two or all of the aforesaid measures as described above is indicative of an improved outcome (e.g., a decrease in disease progression or an improved condition) in the subject.

In other embodiments of the aforesaid methods, the method further includes acquiring a value of a measure of lower extremity and/or ambulatory function in the subject by administering to the subject, e.g., an assessment of short distance ambulatory function (e.g., T25FW test) and/or an assessment of longer distance ambulatory function, e.g., a longer distance walk test (e.g., 6MWT). In one embodiment, the method further includes acquiring a value of a measure of upper extremity function by administering to the subject a 9HP test, wherein:

(i) An increase in the value of disease status or progression by at least 10%, 15%, 20%, 25% or higher in a measure of ambulatory function is indicative of disease progression, e.g., a steady worsening of symptoms and/or disability, in the subject; and

(ii) A decrease in the value of disease status or progression of at least 10%, 15%, 20%, 25% or more in one, two or all of the aforesaid measures as described above is indicative of an improved outcome (e.g., a decrease in disease progression or an improved condition) in the subject.

In certain embodiments, the disease status or progression value is acquired from one, two, or more (or all of) of:

(i) an assessment of lower extremity and/or ambulatory function, e.g., short distance ambulatory function (e.g., T25FW test),

(ii) an assessment of upper extremity function (e.g., 9HP test); or

(iii) an assessment of longer distance ambulatory function, e.g., a longer distance walk test (e.g., 6MWT).

In certain embodiments:

An increase in the value of disease status or progression of at least 10%, 15%, 20%, 25% or more in one, two or all of (i)-(iii) as described above is indicative of disease progression, e.g., a steady worsening of symptoms and/or disability in the subject; and a decrease in the value of disease status or progression of at least 10%, 15%, 20%, 25% or more in one, two or all of (i)-(iii) as described above is indicative of an improved outcome (e.g., a decrease in disease progression or an improved condition) in the subject.

In certain embodiments, the disease status or progression value further includes an assessment of neurological function. In one embodiment, the disease status or progression value include an EDSS. In some embodiments, the EDSS includes an assessment of neurological function and/or an assessment of ambulatory function. In one embodiment, an EDSS score is calculated based on a combination of one or more scores for the EDSS functional systems (FS) (e.g., one, two, three, four, five, six, or all seven individual scores for the EDSS FS chosen from visual, brainstem, cerebellar, motor, sensory, bladder/bowel or cognitive systems). In other embodiments, the EDSS includes a score for ambulation. In one embodiment, the EDSS includes a determination of a subject's ambulation that includes an assessment of one or more (or all) of: Unrestricted ambulation, e.g., without aid or rest for a predetermined distance (e.g., a distance greater or equal to 500, 300, 200, or 100 meters, or less than 200 or 100 meters); unilateral assistance; bilateral assistance; essentially or fully restricted to a wheelchair; or essentially or fully restricted to a bed.

In certain embodiments, the EDSS score is an EDSS total score that is calculated based on a combination of an assessment of neurological function and an assessment of ambulatory function. In one embodiment, the EDSS total score is calculated based on a combination of one or more scores for the EDSS FS (e.g., one, two, three, four, five, six, or all seven individual scores for the EDSS FS chosen from visual, brainstem, cerebellar, motor, sensory, bladder/bowel or cognitive systems) and a score for ambulation, e.g., a determination of a subject's ambulation that includes an assessment of one or more (or all) of: Unrestricted ambulation, e.g., without aid or rest for a predetermined distance (e.g., a distance greater or equal to 500, 300, 200, or 100 meters, or less than 200 or 100 meters); unilateral assistance; bilateral assistance; essentially or fully restricted to a wheelchair; or essentially or fully restricted to a bed.

In other embodiments of the aforesaid methods, the method further includes evaluating the subject's status on the EDSS. In certain embodiments, a value of disease progression includes one or both of:

(i) a change (e.g., an increase) in EDSS total score of at least 1 point, if the change in EDSS total score is determined (or primarily determined) by evaluating a change in neurological function (e.g., one or more changes in neurological systems);

(ii) a change (e.g., an increase) in the EDSS total score of at least 0.5 point, if the change in EDSS total score is determined (or primarily determined) by a change in ambulatory function,

wherein an increase in (i) and/or (ii), as described above is indicative of disease progression, e.g., if confirmed on a second examination at least 3, at least 4, at least 5, or at least 6, months apart (typically, at least 6 months apart); and

wherein a decrease in (i) and/or (ii) as described above is indicative of an improved disease outcome, e.g., if confirmed on a second examination at least 3, at least 4, at least 5, or at least 6, months apart (typically, at least 6 months apart).

In one embodiment, an increase in EDSS total score from baseline of at least 1 point, if the baseline EDSS is less than 4 (e.g., a baseline between 0 and 3.5) is indicative of disease progression, e.g., if confirmed on a second examination at least 3, at least 4, at least 5, or at least 6, months apart (typically, at least 6 months apart).

In another embodiment, a decrease in EDSS total score from baseline of at least 1 point, if the baseline EDSS is less than 4 (e.g., a baseline between 0 and 3.5) is indicative of an improved disease outcome, e.g., if confirmed on a second examination at least 3, at least 4, at least 5, or at least 6, months apart (typically, at least 6 months apart).

In another embodiment, an increase in the EDSS total score of at least 0.5 point, if the baseline EDSS is 4 or greater, is indicative of disease progression, e.g., if confirmed on a second examination at least 3, at least 4, at least 5, or at least 6, months apart (typically, at least 6 months apart).

In another embodiment, a decrease in the EDSS total score of at least 0.5 point, if the baseline EDSS is 4 or greater, is indicative of an improved disease outcome, e.g., if confirmed on a second examination at least 3, at least 4, at least 5, or at least 6, months apart (typically, at least 6 months apart).

Disease progression can include a steady worsening of symptoms and/or disability in the subject.

In yet other embodiments of the aforesaid methods, the value of disease status or progression, includes acquiring one or more of: the subject's status on the EDSS, a measure of upper or lower extremity function, or a measure of ambulatory function (e.g., short or longer distance ambulatory function), wherein one, two or all of the following are indicative of disease progression in the subject:

(i) an increase in EDSS total score of at least 1 point, if the change in EDSS total score is determined (or primarily determined) by evaluating a change in neurological function (e.g., one or more changes in neurological systems), when confirmed on a second examination at least 3, at least 4, at least 5, or at least 6, months apart (typically, at least 6 months apart);

(ii) an increase in the EDSS total score of at least 0.5 point if the change in EDSS total score is determined (or primarily determined) by a change in ambulatory function, when confirmed on a second examination at least 3, at least 4, at least 5, or at least 6, months apart (typically, at least 6 months apart);

(iii) an increase by at least 15% or 20% in a measure of ambulatory function (e.g., short or longer distance ambulatory function, e.g., a T25FW or a 6MWT) when confirmed on a second examination at least 3, at least 4, at least 5, or at least 6, months apart (typically, at least 6 months apart); or

(iv) an increase by at least 15% or 20% in a measure of upper or lower extremity function, e.g., when confirmed on a second examination at least 3, at least 4, at least 5, or at least 6, months apart (typically, at least 6 months apart).

Any of the aforesaid values can be carried out at least one, two, three, four, five, six, seven, eight, nine, ten, eleven or at least twelve months apart. In certain embodiments, the values are obtained at least three, four, five or six months apart. In one embodiment, disease progression is confirmed on a second examination at least 6 months apart.

### MS Therapy

In certain embodiments, the MS therapy comprises one or more of an IFN-β 1 molecule; a polymer of four amino acids found in myelin basic protein, e.g., a polymer of glutamic acid, lysine, alanine and tyrosine (e.g., glatiramer (e.g., Copaxone®)); an antibody or fragment thereof against alpha-4 integrin (e.g., natalizumab (e.g., Tysabri®)); an anthracenedione molecule (e.g., mitoxantrone (e.g., Novantrone®)); or fingolimod (FTY720; Gilenya®); a dimethyl fumarate (e.g., an oral dimethyl fumarate (e.g., Tecfidera®)); an antibody to the alpha subunit of the IL-2 receptor of T cells (e.g., Daclizumab); an antibody to CD52 (e.g., alemtuzumab (e.g., CAMPATH)); leflunomide or an active metabolite thereof, e.g., teriflunomide (e.g., AUBAGIO); or an anti-LINGO-1 antibody.

In one embodiment, the IFNβ1 molecule is an IFN-β1a agent (e.g., Avonex®, Rebif®). In another embodiment, the IFNβ1 molecule is an INF-β 1b agent (e.g., Betaseron®, Betaferon®).

In another embodiment, the IFN-β 1 molecule comprises one or more of an IFN-β 1a or IFN-β1b polypeptide, a variant, a homologue, a fragment or a derivative thereof (e.g., a pegylated variant thereof).

In one embodiment, the MS therapy includes an antibody or fragment thereof against alpha-4 integrin (e.g., natalizumab (Tysabri®)).

In certain embodiments, the method of treatment includes administration of an MS therapy (e.g., a first MS therapy). In another embodiment, the MS therapy is a second or an alternative therapy (e.g., a therapy selected when a patient is less responsive or shows disease progression when treated with the first therapy).

In one embodiment, the first therapy is chosen from one or more of:

(i) an IFNβ agent (e.g., an IFN-β 1a molecule or an IFN-β 1b molecule, including analogues and derivatives thereof (e.g., pegylated variants thereof));

(ii) a polymer of four amino acids found in myelin basic protein, e.g., a polymer of glutamic acid, lysine, alanine and tyrosine (e.g., glatiramer (e.g., Copaxone®));

(iii) a fingolimod (e.g., FTY720; Gilenya®) or other S1P1 agonists; or

(iv) a dimethyl fumarate (e.g., an oral dimethyl fumarate (e.g., Tecfidera®)).

In certain embodiments, the MS therapy is an alternative or second (or further) therapy to the first MS therapy. In one embodiment, the alternative therapy includes an antibody or fragment thereof against alpha-4 integrin (e.g., natalizumab (e.g., Tysabri®). In yet other embodiments, the alternative therapy includes an anthracenedione molecule (e.g., mitoxantrone (e.g., Novantrone®)). In one embodiment, the alternative therapy includes an antibody against CD52 (e.g., alemtuzumab (e.g., Lemtrada®)). In other embodiments, the alternative therapy is an antibody to the alpha subunit of the IL-2 receptor of T cells (e.g., Daclizumab). In yet another embodiment, the alternative therapy includes an anti-LINGO-1 antibody. In another embodiment, the alternative therapy includes a remyelinating agent (e.g., an oral remyelinating agent, e.g., a Sphingosine 1-phosphate (S1P) modulating agent as described in, e.g., WO 2012/109108).

In certain embodiments, the method further includes the use of one or more symptom management therapies, such as antidepressants, analgesics, anti-tremor agents, agents for improvement of walking (e.g., 4-aminopyridine or fampridine) among others.

In other embodiments, the method includes step of administering one or more therapies for management of cognitive and/or memory impairment. Examples of such therapies include, but are not limited to, agents that increase the level of neurotransmitters in the brain, NMDA receptor agents, and CNS stimulants such as dextro- or levo-amphetamines.

### Subjects

For any of the methods disclosed herein, the subject treated, or the subject from which the value is obtained, is a subject having, or at risk of having, MS at any stage of treatment. In certain embodiments, the MS subject is chosen as having one or more of: Benign MS, RRMS (e.g., quiescent RRMS, active RRMS), primary progressive MS (PPMA), secondary progressive MS (SPMS), or progressive-relapsing (PRMS). In one embodiment, the subject has a progressive form of MS, e.g., primary progressive MS, secondary progressive MS, or progressive-relapsing (PRMS). In another embodiment, the subject is asymptomatic.

In other embodiments, the subject has one or more MS-like symptoms, such as those having clinically isolated syndrome (CIS) or clinically defined MS (CDMS). In one embodiment, the subject is an MS patient (e.g., a patient with RRMS, SPMS, PPMS, or PRMS) prior to administration of an MS therapy described herein. In one embodiment, the subject is a newly diagnosed or an undiagnosed RRMS, SPMS, PPMS or PRMS patient. In another embodiment, the subject is an MS patient (e.g., an RRMS, SPMS, PPMS or PRMS patient) after administration of an MS therapy described herein. In other embodiments, the subject is an MS patient after administration of the MS therapy for one, two weeks, one month, two months, three months, four months, six months, one year or more.

In certain embodiments, the subject is a patient having one of: benign MS; relapse/remitting MS (RRMS, e.g., quiescent RRMS, active RRMS); primary progressive MS; secondary progressive MS (SPMS); or progressive-relapsing (PRMS). In one embodiment, the subject has RRMS (e.g., quiescent RRMS, active RRMS). In other embodiments, the subject has primary or secondary progressive MS (PPMS or SPMS).

In certain embodiments, the subject is an MS patient having symptoms of one or more of: primary progressive MS (PPMS), secondary-progressive MS (SPMS); or progressive-relapsing (PRMS).

In one embodiment, the subject has one or more symptoms of sustained disease progression.

The methods described herein can be used to classify MS patients having progressive form of the disease based on relapse-independent or relapse-dependent loss of physical function, e.g., to distinguish among primary progressive MS (PPMS), secondary-progressive MS (SPMS); and progressive-relapsing MS (PRMS).

### Timing of Assessment

In one embodiment, the methods described herein include comparing the disease progression value to a specified value (e.g., a reference value as described herein). A value can be analyzed at any stage of treatment, for example, prior to, during, or after terminating, administration of the MS therapy, to thereby determine appropriate dosage(s) and MS therapy (e.g., amount per treatment or frequency of treatments) for prophylactic or therapeutic treatment of the subject. In certain embodiments, the methods include the step of acquiring the disease status or progression value from the subject, prior to, or after, administering the MS therapy, to the subject.

In one embodiment, the subject has a value of disease status or progression that is based on a baseline assessment of one or more of: the status on the EDSS, upper or lower extremity function, or ambulatory function. In other embodiments, the subject has a value of disease status or progression that is a baseline assessment determined by one or more of: a median value of a patient population for the status on the EDSS, upper or lower extremity function, or ambulatory function.

In one embodiment, the disease status or progression value is assessed at pre-determined intervals, e.g., a first point in time and at least at a subsequent point in time. In certain embodiments, the values are obtained at least three, four, five, six, or twelve months apart.

In one embodiment, a time course is measured by determining the time between significant events in the course of a patient's disease, wherein the measurement is predictive of whether a patient has a long time course. In another embodiment, the significant event is the progression from primary diagnosis to death. In another embodiment, the significant event is the progression from primary diagnosis to worsening disease. In another embodiment, the significant event is the progression from primary diagnosis to relapse or disease progression (e.g., the steady worsening of symptoms, and disability). In another embodiment, the significant event is the progression from secondary MS to death. In another embodiment, the significant event is the progression from remission to relapse or disease progression (e.g., the steady worsening of symptoms, and disability). In another embodiment, the significant event is the progression from relapse or disease progression (e.g., the steady worsening of symptoms and disability) to death. In certain embodiments, the time course is measured with respect to one or more overall survival rate, time to progression and/or using the EDSS and/or other assessment criteria as described herein.

In one embodiment, the disease status or progression value is assessed in an MS patient prior to administration of an MS therapy described herein. For example, the disease status or progression value is assessed in a newly diagnosed MS patient. In another embodiment, the disease status or progression value is assessed in an MS patient after administration of an MS therapy described herein (e.g., after administration of the MS therapy for one, two weeks, one month, two months, three months, four months, six months, one year or more).

In certain embodiments, a pre-determined measure or value is created after evaluating the sample by dividing subject's samples into at least two patient subgroups (e.g., progressors vs. non-progressors). In certain embodiments, the number of subgroups is two, such that the patient sample is divided into a subgroup of patients having a specified value of the disease status or progression value described herein, and a subgroup not having the specified value of the disease progression value. In certain embodiments, the number of subgroups is greater than two, including, without limitation, three subgroups, four subgroups, five subgroups and six subgroups, depending on stratification of predicted MS therapy efficacy as correlated with a particular disease status or progression value.

In one embodiment, the subject is treated with a first MS therapy (e.g., one or more of: an interferon (e.g., an IFNβ agent described herein), glatiramer (e.g., Copaxone®), dimethyl fumarate (e.g., an oral dimethyl fumarate (e.g., Tecfidera®), or a fingolimod (FTY720; Gilenya®)), and shows a value in the range of disease progression or non-progression described herein (thus, indicating that the subject evaluated is non-responsive or responsive to the first MS therapy). A value in the ranges of disease status or progression described herein indicates that the subject evaluated is less responsive to the first MS therapy, and thus, an alternative, second MS therapies can be considered, including, but not limited to, one or more of natalizumab (Tysabri®), mitoxantrone (Novantrone®), an anti-CD52 antibody, e.g., alemtuzumab (Lemtrada®)), an antibody to the alpha subunit of the IL-2 receptor of T cells (e.g., Daclizumab), a remyelinating agent (e.g., an oral remyelinating agent, e.g., a Sphingosine 1-phosphate (S1P) modulating agent as described in, e.g., WO 2012/109108); or an anti-LINGO-1 antibody.

Combination with Other Tests

The methods of the invention can further include the step of monitoring the subject, e.g., for a change (e.g., an increase or decrease) in one or more of: levels of one or more MS biomarkers; the rate of appearance of new lesions, e.g., in an MRI scan; the appearance of new disease-related symptoms; a change in quality of life, or patient or informant-related disease status; cognitive function; or any other parameter related to clinical outcome.

In one embodiment, the methods described herein further include one or more steps of: performing a neurological and/or neuropsychological evaluation, or detecting the subject's lesion status (e.g., as assessed using an MRI), or performing a cognitive function assessment.

In one embodiment, the cognitive function assessment is carried out by administering a learning test, a memory test and/or an attention/processing speed test.

Exemplary tests for evaluating memory factors include, but are not limited to, tests for evaluating one or more of auditory memory, verbal learning and/or remembering visual information (e.g., Selective Reminding Test (SRT)); tests for evaluating auditory/verbal memory (e.g., California Verbal Learning Test Second Edition (CVLT2)), or the Rey Auditory Verbal Learning Test (RAVLT); and tests for evaluating visual/spatial memory (e.g., Brief Visuospatial Memory Test Revised (BVMTR)).

Exemplary tests for evaluating attention, e.g., processing speed and/or working memory, include but are not limited to, tests for evaluating one or more of working memory, processing speed (e.g., auditory information processing speed), flexibility or calculation ability (e.g., Paced Auditory Serial Addition Test (PASAT)); and tests for evaluating complex scanning and/or visual tracking (e.g., Symbol Digit Modalities Test (SDMT)).

The subject can be monitored in one or more of the following periods: prior to beginning of treatment; during the treatment; or after the treatment has been administered, or during interruptions of treatment. Monitoring can be used to evaluate the need for further treatment with the same MS therapy, or for additional MS treatment.

### Kits

In another aspect, the invention features kits for acquiring a disease status or progression value for a subject, e.g., an MS patient. The kit can include means or tests for evaluating one, two, three or more clinical impairment factors described herein. In certain embodiments, the kit includes one or two of:

(i) an assessment of ambulatory function, e.g., short distance ambulatory function (e.g., T25FW), or longer distance ambulatory function (e.g., 6MWT) as described herein; or

(ii) an assessment of upper extremity function (e.g., 9HP) as described herein,

and means for determining the disease status or progression value.

In one embodiment, the kit further comprises an assessment of neurological and/or ambulatory function (e.g., EDSS) as described herein.

In one embodiment, the kit includes one or more (or all) of:

(i) an assessment of neurological function; or

(ii) an assessment of physical function. For example, an assessment of physical function can include an assessment of ambulatory function (e.g., short distance ambulatory function and/or longer distance ambulatory function), alone or in combination with an assessment of upper and/or lower extremity function.

### Reports

The methods, systems, and/or kits described herein can further include providing or generating, and/or transmitting information, e.g., a report, containing data of the evaluation or treatment determined by the methods, and/or kits as described herein. In one embodiment, the disease status or progression value is memorialized. The value or information can be transmitted to a report-receiving party or entity (e.g., a patient, a health care provider, a diagnostic provider, and/or a regulatory agency, e.g., the FDA), or otherwise submitting information about the methods and kits disclosed herein to another party. The method can relate to compliance with a regulatory requirement, e.g., a pre- or post approval requirement of a regulatory agency, e.g., the FDA. In one embodiment, the report-receiving party or entity can determine if a predetermined requirement or reference value is met by the data, and, optionally, a response from the report-receiving entity or party is received, e.g., by a physician, patient, diagnostic provider.

In other embodiments, a method for generating a report, includes acquiring a disease status or progression value comprising (i) an assessment of ambulatory function, e.g., short distance ambulatory function (e.g., T25FW), or longer distance ambulatory function (e.g., 6MWT), and/or (ii) an assessment of upper extremity function (e.g., 9HP, in a subject (e.g., a patient, a patient group or a patient population), having multiple sclerosis (MS), or at risk for developing MS, prior to, during, and/or after the MS therapy; and memorializing the value acquired. In one embodiment, the disease status or progression value comprises an assessment of neurological and/or ambulatory function (e.g., EDSS as described herein).

### Systems

In another aspect, the invention features a system for evaluating a subject (e.g., a patient, a patient group or a patient population). The system includes at least one processor operatively connected to a memory, and at least one processor connected to processing speed/complex attention:

determine or calculate a disease status or progression value associated with the subject, wherein the processor is further configured to determine or calculate the value of disease progression responsive to establishing one or two of:

(i) an assessment of ambulatory function, e.g., short distance ambulatory function (e.g., T25FW), or longer distance ambulatory function (e.g., 6MWT) as described herein, and/or

(ii) an assessment of upper extremity function (e.g., 9HP test), for the subject; and

evaluate the subject, based on at least one value of the disease progression established, e.g., prior to, during, or after the conclusion of, an MS therapy, or established responsive to administration of an MS therapy.

In one embodiment, the system determines or calculates a disease status or progression value that comprises an assessment of neurological and/or ambulatory function (e.g., EDSS).

In a related aspect, the invention features a system for monitoring a subject (e.g., monitoring disease progression in the subject), having multiple sclerosis (MS), or at risk for developing MS, comprising:

at least one processor operatively connected to a memory, wherein the at least one processor when executing is configured to:

establish a disease status or progression value associated with the subject, prior to, during, and/or after an MS therapy, wherein the processor is further configured to establish the disease status or progression value responsive to establishing one or two of:

(i) an assessment of ambulatory function, e.g., short distance ambulatory function (e.g., T25FW), or longer distance ambulatory function (e.g., 6MWT) as described herein, and/or

(ii) an assessment of upper extremity function (e.g., 9HP test), for the subject;

compare the disease progression value from the subject to a reference value, e.g. a reference value as described herein,

(optionally) establish a reference value reflective of a severity of MS associated with the subject, and

identify an indication of steady or decreased disease progression (or improved outcome) in the subject in response to MS therapy, wherein identifying the indication of steady or decreased disease progression (or improved outcome) includes detecting a similar or a decrease in the disease status or progression value, relative to the reference value (e.g., a reference value described herein); or

identify an indication of increased disease progression in the subject in response to MS therapy, wherein identifying the indication of increased disease progression includes detecting an increase in the disease status or progression value, relative to the reference value (e.g., a reference value described herein).

In one embodiment, the system determines or calculates a disease progression value that comprises an assessment of neurological and/or ambulatory function (e.g., EDSS).

In certain embodiments of the systems as described herein, the processor when executing is further configured to perform one or more of:

comparing the value of disease status or progression from the subject to a specified parameter, e.g., a reference value as described herein. In one embodiment, the reference value is a value, e.g., a norm value, from a general population matched by one, two or all of age, sex and/or level of education;

identifying the subject as being in need of an MS therapy;

recommending administration of an additional (add-on) MS therapy;

determining or altering a dosing of the MS therapy;

determining or altering a schedule or a time course of the MS therapy; or

recommending an alternative MS therapy.

In one embodiment of the systems as described herein, the processor when executing is further configured to establish the reference value with another value for a patient having a different form of MS (e.g., comparing a patient with relapse remitting multiple sclerosis (RRMS) to a reference value for a patient with secondary progressive multiple sclerosis (SPMS); or comparing a reference value from patients having different form of progressive MS (e.g., patients with SPMS, PPMS or PRMS).

In another embodiment, the processor when executing is further configured to identify an indication of improved function in the subject, wherein identifying the indication of improved function includes detecting a decrease in the disease progression value, relative to the reference value.

In yet another embodiment, the processor when executing is further configured to identify an indication of decreased function in the subject, wherein identifying the indication of decreased function includes detecting an increase in the disease progression value, relative to the reference value.

The reference value can be adjusted based at least in part on the timing of establishing a first disease status or progression value and at least one subsequent disease status or progression value.

In yet other embodiments of the system, the processor when executing is further configured to determine the value of the disease status or progression parameter based on evaluation of an assessment of upper extremity function (e.g., 9HP test) alone or in combination with an assessment of neurological and/or ambulatory function (e.g., EDSS), and/or an assessment of ambulatory function (e.g., short distance ambulatory function (e.g., T25FW test) or longer distance ambulatory function (e.g., 6MWT).

In other embodiments of the system, the processor when executing is configured to determine one, two, three or more clinical impairment factors described herein, at least in part, from administering, or on the results from administration, of one, two, three or more (or all) of:

(i) an assessment of neurological and/or ambulatory function (e.g., EDSS),

(ii) an assessment of short distance ambulatory function (e.g., T25FW),

(iii) an assessment of upper extremity function (e.g., 9HP), or

(iv) an assessment of longer distance ambulatory function (e.g., a timed (e.g., 5- or 6-minute) walk test (e.g., 6MWT)).

In one embodiment, the assessment includes a verbal instruction. In other embodiments, the assessment is supplied by an electronic means, e.g., a tablet; the electronic means can be used to capture the response.

In yet other embodiments of the system, the processor when executing is further configured to establish the reference value from one or more values obtained from testing of at least one of: a healthy subject or an average of healthy subjects; the subject at different time intervals (e.g., prior to, during, or after the MS therapy); a group of MS patients having the same or different disease progressions; the group of MS patients having the same or different disease progressions at different time intervals; a group of MS patients undergoing different MS treatments than the subject; a group of MS patients undergoing a same MS treatment as the subject; or a general population matched by one, two or all of age, sex and/or level of education.

In other embodiments of the system, the processor when executing is further configured to compute an average value of one or more clinical impairment factors to determine the value of disease status or progression.

In other embodiments of the system, the processor when executing is further configured:

(i) To detect a change (e.g., an increase) in the value of disease status or progression of at least 10%, 15%, 20%, 25% or more in a measure of upper or lower extremity function in the subject. In one embodiment, the measure of upper extremity function is determined by administering to the subject a 9-HPT test;

(ii) To detect a change (e.g., an increase) in the value of disease status or progression of at least 10%, 15%, 20%, 25% or more in a measure of ambulatory function in the subject. In one embodiment, the measure of ambulatory function (e.g., short distance ambulatory function) is determined by administering to the subject a (T25FW test). In another embodiment, the measure of ambulatory function (e.g., longer distance ambulatory function) is determined by administering to the subject a timed (e.g., 5- or 6-minute) walk test (e.g., 6MWT);

wherein an increase in (i) and/or (ii) as described above is indicative of disease progression, e.g., a steady worsening of symptoms and/or disability in the subject; and

wherein an decrease in (i) and/or (ii) as described above is indicative of an improved outcome (e.g., a decrease in disease progression), in the subject.

and/or

(iii) To detect a change (e.g., an increase) in EDSS total score of at least 1 point, if the change in EDSS total score is determined (or primarily determined) by evaluating a change in neurological function (e.g., one or more changes in neurological systems);

(iv) To detect a change (e.g., an increase) in the EDSS total score of at least 0.5 point if the change in EDSS total score is determined (or primarily determined) by a change in ambulatory function,

wherein an increase in (iii) and/or (iv), as described above is indicative of disease progression, e.g., if confirmed on a second examination at least 3, at least 4, at least 5, or at least 6, months apart (typically, at least 6 months apart); and

wherein a decrease in (iii) and/or (iv) as described above is indicative of an improved disease outcome, e.g., if confirmed on a second examination at least 3, at least 4, at least 5, or at least 6, months apart (typically, at least 6 months apart).

In other embodiments of the system, the processor when executing is further configured to perform one or more of the following responsive to a determination or comparison of the value of disease status or progression:

(1) stratify a patient population, wherein stratifying the patient population includes at least one of assigning a subject to a group or class having a common diagnostic characteristic;

(2) identify or select the subject as likely or unlikely to respond to a treatment;

(3) select a treatment option, including a determination to administer or not administer a preselected MS therapy; or

(4) generate a probabilistic model of the time course of the disease in the subject, including a determination of the likelihood of increased or decreased patient survival.

In other embodiments of the system, the processor when executing is further configured to:

store the disease status or progression value, and

generate a report including analysis of the stored disease status or progression value, wherein the analysis is reflective of a status of the subject having MS.

In other embodiments of the system, the processor when executing is further configured to communicate information regarding a patient population including a plurality of the disease status or progression value corresponding to a plurality of subjects.

In other embodiments of the system, the processor when executing is further configured to communicate information regarding an evaluation of a subject or treatment to a report-receiving party or entity (e.g., a patient, a health care provider, a diagnostic provider, and/or a regulatory agency, e.g., the FDA).

In other embodiments of the system, the processor when executing is further configured to:

store a disease status or progression value comprising, in a subject having multiple sclerosis (MS), or at risk for developing MS, prior to, during, and/or after the MS therapy; and

generate a correlation between the stored disease status or progression value and diagnosis of a status of the subject having MS;

communicate the correlation and the diagnosis to at least one of a health care provider, a diagnostic provider, and a regulatory agency.

In another aspect, the invention features system for establishing a quantitative value (e.g., one or more quantitative values) for assessing MS disease status or progression. The system includes:

at least one processor operatively connected to a memory;

a scoring component, executed by the at least one processor, configured to execute scoring rules;

a rules object accessible by the scoring component defining a plurality of scoring rules for combining assessment values;

a user interface, executed by the at least one processor, configured to display selection criteria for evaluating ambulation of a patient, wherein the user interface is configured to accept for scoring a single selected category within a plurality of displayed ambulation categories;

wherein the scoring component is configured to:
identify a plurality of scoring rules associated with the selected category for combining a plurality of scores for patient functionality, and
generate the quantitative value for MS disease status or progression responsive to execution of the plurality of scoring rules.

In one embodiment, the user interface of the system is configured to accept one or more EDSS functional system (FS) scores for assessing a subject, e.g., one, two, three, four, five, six, or all seven individual scores for the EDSS FS chosen from visual, brainstem, cerebellar, motor, sensory, bladder/bowel or cognitive systems.

In another embodiment, the scoring component of the system combines the one or more EDSS functional system scores with an ambulation score associated with the selected category to generate the quantitative value.

In another embodiments, the rules object of the system includes a plurality of category definitions for assessing a subject's ambulation. The plurality of category definitions can include at least 4, 5, 6, 7, 8, 9, 10, 12, 13, 14, 15, 16 or more options for assessing a subject's ambulation, wherein each option is associated with an ambulation score. For example, the plurality of category definitions comprise one or more (or all) of: Unrestricted ambulation, e.g., without aid or rest for a predetermined distance (e.g., a distance chosen from a distance greater or equal to 500, 300, 200, or 100 meters, or less than 200 or 100 meters); unilateral assistance; bilateral assistance; essentially or fully restricted to a wheelchair; or essentially or fully restricted to a bed.

In other embodiments, the rules object of the system includes a plurality of category definitions that include one or more of: one to six categories for assessing ambulation without aid or rest, one or two categories for assessing ambulation with unilateral assistance, one or two categories for assessing ambulation with bilateral assistance, or one to six categories for assessing restricted ambulation.

In another embodiment, the system further includes an evaluation component, executed by the at least one processor, configured to evaluate a user-entered quantitative value for MS disease status or progression. In one embodiment, the evaluation component is configured to determine that a user-entered quantitative value is inconsistent with a corresponding calculated value.

In another embodiment, the user interface of the system is configured to constrain one or more input EDSS functional system scores to a valid value, e.g., a converted functional score). In one embodiment, the user interface of the system is configured to display a notification regarding a likely error responsive to user accessing data input fields. For example, the user interface is configured to display a notification regarding a converted functional score for a visual or bowel/bladder functional system scores, or both.

In other embodiments, the user interface of the system is configured to evaluate an input value to determine consistency with a scoring rule in real time.

In yet other embodiments, the system further includes an administration component configured to update the rules object. In one embodiment, the administration component is configured to define at least one active rule for execution. The administration component can be configured to mark an existing rule as an inactive rule, wherein the inactive rule is not executed for establishing the quantitative value for assessing MS disease status or progression. In one embodiment, defining the at least one active rule for execution includes at least one of updating an existing scoring rule and creating a new scoring rule responsive to a change in approved scoring criteria.

In other embodiments, the system further includes a pre-qualification component configured to evaluate a pre-treatment scoring of an individual subject. The pre-qualification component can be configured to identify a candidate with a pre-treatment score within a pre-defined threshold. In one embodiment, the pre-qualification component is configured to identify a candidate with a pre-treatment score exceeding a pre-defined threshold. In other embodiments, the pre-qualification component is configured to define a candidate population for inclusion in a clinical trial responsive to evaluation of the pre-defined threshold.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In addition, the materials, methods, and examples are illustrative only and not intended to be limiting.

Other features and advantages of the invention will be apparent from the detailed description, drawings, and from the claims.

### BRIEF DESCRIPTION OF THE FIGURES

FIG. 1A is a point graph depicting the change in the T25FW score over 2 years by EDSS step at baseline, in 219 SPMS subjects randomized to placebo in the IMPACT study (Cohen et al. (2002) Mult Scler 8(2):142-154; Cohen (2002) Neurology 59(5):679-687). The circle shows the responsiveness of the T25FW is limited mostly to subjects who entered the trial at EDSS steps ≧6. FIG. 1B is a bar graph depicting the annualized increase in the total EDSS score by EDSS step at entry in a large MS clinic in Europe (Ravnborg, et al. (2005) Mult Scler. 11(1):81-4). The circle shows the poor responsiveness of the EDSS for subjects in the 5-7 EDSS step range relative to the subjects in the EDSS 1-4 step range. FIG. 1C is a point graph depicting the change in the 9HP score over 2 years by EDSS step at baseline, in 219 SPMS subjects randomized to placebo in the IMPACT study (Cohen et al., (2002) Mult Scler 8(2): 142-154; Cohen (2002) Neurology 59(5):679-687). The circle shows the responsiveness of the HP9 across a wide EDSS step range (wider EDSS step range compared to the T25FW, see FIG. 1A). FIG. 1D is a graph depicting the proposed components of the disease progression value by their responsiveness over 2 years across the EDSS steps at entry into a clinical trial study.

FIG. 2 is a bar graph depicting the clinical meaningfulness of the ‘at least 20% worsening’ cutoff on the T25FW test based on patient's self reporting using the Guy's Neurological Disability Scale (GNDS) (Hoogervorst et al. (2004) Mult Scler. 10(5):569-74; Hoogervorst et al. (2004) Mult Scler. 10(1):55-60).

FIG. 3 is a timeline depicting an exemplary strategy for confirmation of progression of patients in a clinical trial who have a clinical relapse using the disease progression value.

FIG. 4 is a timeline depicting an example strategy for the confirmation of progression of patients who withdraw from a clinical trial study prematurely using the disease progression value.

FIG. 5 illustrates an example process 300 that can be executed on a computer system for defining correlations between a disease progression value and progression of MS or MS symptoms in a subject.

FIG. 6 shows an example block diagram of a general-purpose computer system 400 which can be especially configured to practice various aspects of the invention discussed herein.

FIG. 7 is a schematic of a storage device 412.

FIG. 7 shows an architecture diagram of an example distributed system 600

FIG. 8 is a schematic of general-purpose computer systems 604, 606, and 608 communicating over network 602;

FIGS. 9A-B is an example calculation table, according to one embodiment;

FIG. 10 is a block diagram of an example system, according to one embodiment; and

FIG. 11 illustrates an example process for calculating an assessment value according to one embodiment.

### DETAILED DESCRIPTION OF THE INVENTION

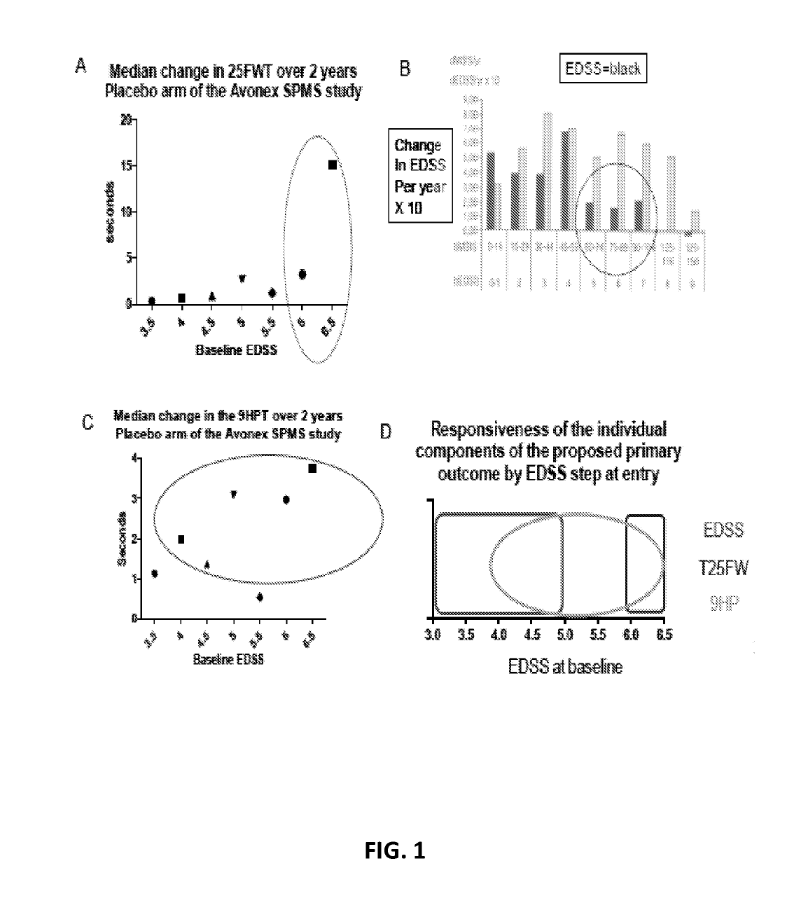

Current methodologies for evaluating MS patients, e.g., the EDSS, have been useful in RRMS clinical research because they can capture changes across combinations of neurological systems in the MS patient population. However, these methodologies are less reliable when used to evaluate progressive forms of MS, e.g., SPMS, PPMS and PRMS (Cohen et al., (2002) Mult Scler 8(2): 142-154). For example, most of the patients enter SPMS clinical trials with baseline EDSS scores of 3.5 or higher, at which point progression is determined almost exclusively by large, threshold-based worsening of ambulation. Furthermore, over 50% of subjects enter SPMS clinical trials at EDSS steps of 6 or 6.5 where the EDSS is least responsive (FIG. 1B). As a result, the EDSS alone is inadequate to examine the therapeutic efficacy of drugs for progressive forms of MS. These limitations of the EDSS have been highlighted by several investigators over the last 20 years ((Ebers et al., (2008) Neurology 71: 624-63); (Wingerchuk et al. (1997) Mayo Clinic Proceedings 72: 1070-1079); (Noseworthy et al., (1994) Ann Neurol 36 Suppl: S80-85); Noseworthy et al. (1990) Neurology 40: 971-975). Thus, the EDSS alone is generally insufficient to investigate progressor status or therapeutic efficacy in progressive forms of MS due to: (1) a limited sensitivity in the higher EDSS range, e.g., 6-6.5; (2) a lack of responsiveness to worsening in non-ambulatory functions, and (3) problems inherent to the scale due, e.g., to random variation, lack of linearity (FIG. 1B), and measurement errors (Ebers et al. (2008) supra). Additional clinical measures that supplement the sensitivity of this endpoint are required in order to adequately characterize progressive forms of MS and to evaluate progressor status, as well as treatment effects on disease progression in progressive forms of MS. Better definitions of what constitutes a confirmed change are also needed to control for the variability of the measurement, especially in the lower range of the scale (≦5.5).

Further aspects are directed to systems and methods for developing consistency in assessment scoring, for example, by physicians. In some implementations, scoring rules are implemented through system executed logic, where input data can be validated for consistency during entry and the ultimate calculation of values is executed in a consistent and accurate manner across every input. It is realized that physician controlled approaches that require the physician to understand and correctly apply a variety of scoring rules can be subject to variation and can be error prone. For example, calculation errors can be readily identified based on inconsistent application of scoring rules. Transcription errors likewise skew results and prevent accurate comparison. According to some aspects, performing such calculations through system executed rules insures consistency and accuracy of results. In some implementations, a scoring system can also evaluate values entered into the system to determine consistency with scoring rules, where errors or inconsistent results can be flagged for review. An exemplary system and method for EDSS scoring is disclosed herein.

Accordingly, methods, systems and kits for the identification, assessment and/or treatment of a subject having a neurological disorder, e.g., a progressive form of MS are disclosed. In one embodiment, the methods, systems and kits include the step of detecting and/or quantifying disease progression in the subject (e.g., a subject with primary or secondary progressive multiple sclerosis (PPMS or SPMS, respectively), or a subject with progressive-relapsing MS (PRMS)). In certain embodiments, the methods, systems and kids include acquiring a value of disease status or progression (also referred to individually herein as “disease status value” or “disease progression value,” respectively, or by shorthand “disease status or progression value”). In one embodiment, the disease progression value includes a measure of upper and/or lower extremity function, and/or a measure of ambulatory function other than the Expanded Disability Status Scale (EDSS). A measure of upper and/or lower extremity function, and/or a measure of ambulatory function (e.g., short and/or longer distance ambulatory function) can be used in combination with other MS evaluating methodologies, such as the EDSS. Scoring systems for facilitating data collection and calculation of assessment values are also disclosed. The use of the aforesaid measures in the primary outcome covering both upper and lower extremity functions that are responsive across a wide range of disabilities, provides a comprehensive assessment of treatment effects on progression of physical disability over years (FIG. 1D). Thus, the methods, systems and kits disclosed herein provide several advantages over existing methodologies, including, but not limited to, increased sensitivity in the higher EDSS range; increased responsiveness to worsening in non-long distance ambulatory functions; automated execution of scoring methodologies; improved scoring accuracy and consistency; and decreased problems inherent to the EDSS scale due to, e.g., random variation, lack of linearity, measurement errors, and interpretation errors in scoring.

Therefore, the invention can be used, for example, for one or more of: (i) diagnosing, prognosing and/or evaluating, a subject (e.g., a subject having a progressive neurological disorder, e.g., a progressive form of MS) or conversion from RRMS to SPMS; (ii) evaluating responsiveness to, or monitoring, a therapy (e.g., an MS therapy); (iii) identifying a patient as being stable, showing improvement or showing disease progression; (iv) to stratify a subject (e.g., an MS patient or patient population) as being a disease non-progressor or a disease progressor; (v) characterizing progressive form of MS; and/or (vi) more effectively monitoring, treating multiple sclerosis, or preventing worsening of disease progression and/or relapses.

Various aspects of the invention are described in further detail in the following subsections.

### DEFINITIONS

As used herein, each of the following terms has the meaning associated with it in this section.

As used herein, the articles “a” and “an” refer to one or to more than one (e.g., to at least one) of the grammatical object of the article.

The term “or” is used herein to mean, and is used interchangeably with, the term “and/or”, unless context clearly indicates otherwise.

As used herein, a “disease progression value” includes a measure (e.g., one or more measures) of a worsening, stability, or improvement of one or more symptoms and/or disability in a subject. In certain embodiments, disease progression is evaluated as a steady worsening, stability, or improvement of one or more symptoms and/or disability over time, as opposed to a relapse, which is relatively short in duration. In certain embodiments, the disease progression value is acquired in a subject with a progressive form of MS (e.g., a subject with primary or secondary progressive multiple sclerosis (PPMS or SPMS, respectively), or a subject with progressive-relapsing MS (PRMS)).

As used herein, a “disease status value” includes a measure (e.g., one or more measures) of one or more symptoms and/or disability in a subject, e.g., an MS subject as described herein. The term “disease status value” can include a disease progression value; however, it encompasses any status (e.g., worsening, stability or improvement) of a neurological disease in a subject, including, for example, steady worsening or relapse of MS.

In certain embodiments, the disease status or progression value includes a measure of upper extremity function (e.g., a 9HP assessment). Alternatively or in combination, the disease status or progression value includes a measure of lower extremity function. Alternatively or in combination, the disease progression value includes a measure of ambulatory function, e.g., short distance ambulatory function (e.g., T25FW). Alternatively or in combination, the disease progression value includes a measure of ambulatory function, e.g., longer distance ambulatory function (e.g., a 5 or 6-minute walk test). In one embodiment, the disease status or progression value includes a measure of ambulatory function other than EDSS ambulatory function. In one embodiment, the disease status or progression value includes a measure of upper extremity function (e.g., a 9HP assessment) and a measure of ambulatory function, e.g., short distance ambulatory function (e.g., T25FW). In one embodiment, the disease status or progression value includes a measure of upper extremity function (e.g., a 9HP assessment) and a measure of lower extremity function. In one embodiment, the disease status or progression value includes a measure of upper extremity function (e.g., a 9HP assessment), a measure of lower extremity function, and a measure of ambulatory function, e.g., short distance ambulatory function (e.g., T25FW) and/or longer distance ambulatory function (e.g., a timed (e.g., 5- or 6-minute) walk test (e.g., 6MWT)). In one embodiment, one, two or the combination of the T25FW, 6MWT and 9HP assessments can be used to acquire a disease status or progression value. The measure of ambulatory function (e.g., short distance ambulatory function (e.g., T25FW) or longer distance ambulatory function (e.g., a timed (e.g., 5- or 6-minute) walk test (e.g., 6MWT)) and/or measure of upper extremity function (e.g., a 9HP assessment) can further be used in combination with the EDSS to evaluate MS, e.g., progressive forms of MS.

The disease status or progression value disclosed herein can be used as a means to confirm progression or non-progression in MS patients. In certain embodiment, the disease progression value includes individual component parameters of one or more of the T25FW, the 6MWT, the 9HP, or the EDSS assessments. In one embodiment, a progressor is a subject who possesses a disease progression value reflecting at least one, two or all of the following criteria:

a. confirmed progression in T25FW: Time taken for 25-foot walk increased by at least 15% or 20% of the baseline walk, confirmed at a second time point at least 3, 4, 5, or 6 months apart;

b. confirmed progression in a timed (e.g., 5- or 6-minute) walk test (e.g., 6MWT): Time taken for walk increased by at least 15% or 20% of the baseline walk, confirmed at a second time point at least 3, 4, 5, or 6 months apart;

c. confirmed progression in 9HP: Time taken for 9-hole peg increased by at least 15% or 20% of the time taken at baseline, confirmed at a second time point at least 3, 4, 5, or 6 months apart. The progression in 9HP can occur on either hand, but will have to be confirmed on the same hand; and/or

d. confirmed progression in EDSS:

(i) EDSS total score increase from baseline by at least 1 point, if the change in EDSS total score is determined (or primarily determined) by evaluating a change in neurological function (e.g., one or more changes in neurological systems); and/or

(ii) EDSS total score increased from baseline by at least 0.5 point if the change in EDSS total score is determined (or primarily determined) by a change in ambulatory function,

if either or both of (i) or (ii) is/are confirmed on a second examination at least 3, 4, 5 or 6 months apart (typically, at least 6 months apart).

Baseline values for the aforementioned tests (e.g., T25FW, 6MWT, EDSS, or 9HP) can be determined using the best baseline value or the average baseline value.

“Acquire” or “acquiring” as the terms are used herein, refer to obtaining possession of, determining, or evaluating, a value, e.g., a numerical value, by “directly acquiring” or “indirectly acquiring” the value. “Directly acquiring” means performing a process (e.g., performing a test, e.g., a measure of upper and/or lower extremity function, and/or ambulatory function) to obtain the value. “Indirectly acquiring” refers to receiving the value from another party or source (e.g., a third party clinician or health professional that directly acquired the value).

Multiple sclerosis is “treated,” “inhibited” or “reduced,” if at least one symptom of the disease is reduced, alleviated, terminated, slowed, or prevented. As used herein, multiple sclerosis is also “treated,” “inhibited,” or “reduced,” if recurrence or relapse of the disease is reduced, slowed, delayed, or prevented. Exemplary clinical symptoms of multiple sclerosis that can be used to aid in determining the disease status in a subject can include e.g., tingling, numbness, muscle weakness, loss of balance, blurred or double vision, slurred speech, sudden onset paralysis, lack of coordination, cognitive difficulties, fatigue, heat sensitivity, spasticity, dizziness, tremors, gait abnormalities, speech/swallowing difficulties, and extent of lesions assessed by imaging techniques, e.g., MRI. Clinical signs of MS are routinely classified and standardized, e.g., using an EDSS rating system based on neurological examination and long distance ambulation. For the lower end of the scale (1-5.5) a decrease of one full step indicates an effective MS treatment (Kurtzke, Ann. Neurol. 36:573-79, 1994), while an increase of one full step will indicate the progression or worsening of the disease (e.g., exacerbation). For the higher end of the scale (5-7), a half a point typically indicates improvement (a reduction) or worsening (an increase).

As used herein, the “Expanded Disability Status Scale” or “EDSS” is intended to have its customary meaning in the medical practice. EDSS is a rating system that is frequently used for classifying and standardizing MS. The accepted scores range from 0 (normal) to 10 (death due to MS). Typically patients having an EDSS score of about 4-6 will have moderate disability (e.g., limited ability to walk), whereas patients having an EDSS score of about 7 or 8 will have severe disability (e.g., will require a wheelchair). More specifically, EDSS scores in the range of 1-3 refer to an MS patient who is fully ambulatory, but has some signs in one or more functional systems; EDSS scores in the range higher than 3 to 4.5 show moderate disability; an EDSS score of 5 to 5.5 refers to a disability impairing or precluding full daily activities; EDSS scores of 6 to 6.5 refer to an MS patient requiring intermittent to constant, or unilateral to bilateral constant assistance (cane, crutch or brace) to walk; EDSS scores of 7 to 7.5 means that the MS patient is unable to walk beyond five meters even with aid, and is essentially restricted to a wheelchair; EDSS scores of 8 to 8.5 refer to patients that are restricted to bed; and EDSS scores of 9 to 10 mean that the MS patient is confined to bed, and progressively is unable to communicate effectively or eat and swallow, until death due to MS.

“Responsiveness,” to “respond” to treatment, and other forms of this verb, as used herein, refer to the reaction of a subject to treatment with an MS therapy. As an example, a subject responds to an MS therapy if at least one symptom of multiple sclerosis (e.g., disease progression) in the subject is reduced or retarded by about 10%, 20%, 30%, 40%, 50%, 60%, 70%, 80%, 90% or more. In another example, a subject responds to an MS therapy, if at least one symptom of multiple sclerosis in the subject is reduced by about 5%, 10%, 20%, 30%, 40%, 50% or more as determined by any appropriate measure, e.g., one or more of: a measure of upper or lower extremity function, a measure of ambulatory function, or an assessment of EDSS. In another example, a subject responds to treatment with an MS therapy, if the subject has an increased time to progression. Several methods can be used to determine if a patient responds to a treatment including the assessments described herein, as set forth above.

A “non-responder” or “progressor” refers to a subject, e.g., an MS patient, if in response to an MS therapy (e.g., an MS therapy described herein), at least one symptom or disability of multiple sclerosis in the subject is reduced by less than about 5%, as determined by any appropriate measure, e.g., one or more of: a measure of upper or lower extremity function, a measure of ambulatory function, or an assessment of EDSS. In one embodiment, a progressor is a subject who possesses a disease progression value reflecting at least one of the following criteria:

a. confirmed progression in T25FW: Time taken for 25-foot walk increased by at least 15% or 20% of the baseline walk, confirmed at a second time point at least 3, 4, 5, or 6 months apart;

b. confirmed progression in a timed (e.g., 5- or 6-minute) walk test (e.g., 6MWT): Time taken for walk increased by at least 15% or 20% of the baseline walk, confirmed at a second time point at least 3, 4, 5, or 6 months apart;

c. confirmed progression in 9HP: Time taken for 9-hole peg increased by at least 15% or 20% of the time taken at baseline, confirmed at a second time point at least 3, 4, 5, or 6 months apart. The progression in 9HP can occur on either hand, but will have to be confirmed on the same hand; and/or

d. confirmed progression in EDSS:

(i) EDSS total score increased from baseline by at least 1 point, if the change in EDSS total score is determined (or primarily determined) by evaluating a change in neurological function (e.g., one or more changes in neurological systems); and/or

(ii) EDSS total score increased from baseline by at least 0.5 point if the change in EDSS total score is determined (or primarily determined) by a change in ambulatory function,

if either or both of (i) or (ii) is/are confirmed on a second examination at least 3, 4, 5 or 6 months apart (typically, at least 6 months apart).

Baseline values for the aforementioned tests (e.g., T25FW, 6MWT, EDSS, or 9HP) can be determined using the best baseline value or the average baseline value.

A “responder” or “non-progressor” refers to a subject, e.g., an MS patient, if in response to an MS therapy (e.g., an MS therapy described herein), at least one symptom or disability of multiple sclerosis in the subject is reduced by about 5%, 10%, 20%, 30%, 40%, 50% or more as determined by any appropriate measure, e.g., one or more of: a measure of upper or lower extremity function, a measure of ambulatory function, or an assessment of EDSS. In one embodiment, a responder or non-progressor is defined as a subject with no confirmed relapses and/or no evidence of sustained disability progression (by EDSS) during at least six months, a year, or the first three years of treatment (e.g., clinical remission).

As used herein, “significant event” shall refer to an event in a patient's disease that is important as determined by one skilled in the art. Examples of significant events include, for example, without limitation, primary diagnosis, death, recurrence, remission, relapse of a patient's disease or the progression of a patient's disease from any one of the above noted stages to another. A significant event can be any important event used determine disease status using e.g., EDSS or other symptom criteria, as described herein or determined by one skilled in the art.

As used herein, “time course” shall refer to the amount of time between an initial event and a subsequent event. For example, with respect to a patient's disease, time course can relate to a patient's disease and can be measured by gauging significant events in the course of the disease, wherein the first event can be diagnosis and the subsequent event can be remission or relapse, for example.

Various aspects of the invention are described in further detail below. Additional definitions are set out throughout the specification.

### Multiple Sclerosis and Methods of Diagnosis

Multiple sclerosis (MS) is a central nervous system disease that is characterized by inflammation and loss of myelin sheaths and axons, and reactive changes (e.g., microgliosis, astrogliosis).

Patients having MS can be identified by clinical criteria establishing a diagnosis of clinically definite MS as defined by Poser et al. (1983) Ann. Neurol. 13:227. Briefly, an individual with clinically definite MS has had two attacks and clinical evidence of either two lesions or clinical evidence of one lesion and paraclinical evidence of another, separate lesion. Definite MS may also be diagnosed by evidence of two attacks and oligoclonal bands of IgG in cerebrospinal fluid or by combination of an attack, clinical evidence of two lesions and oligoclonal band of IgG in cerebrospinal fluid. The McDonald criteria can also be used to diagnose MS. (McDonald et al. (2001) Ann. Neurology 50(1): 121-127; Polman, C. H. et al. (2011) Ann. Neurol. 69(2):292-302). The McDonald criteria include the use of MRI evidence of CNS impairment over time to be used in diagnosis of MS, in the absence of multiple clinical attacks. Effective treatment of multiple sclerosis may be evaluated in several different ways. The following parameters can be used to gauge effectiveness of treatment. Two exemplary criteria include: EDSS (extended disability status scale), and appearance of exacerbations clinically and on MRI (magnetic resonance imaging).

Exacerbations are defined as the appearance of a new symptom that is attributable to MS and accompanied by an appropriate new neurologic abnormality (Schumacher et al. (1965) Annals of the New York Academy of Sciences 122: 552-568). In addition, the exacerbation must last at least 24 hours and be preceded by stability or improvement for at least 30 days. Briefly, patients are given a standard neurological examination by clinicians. Exacerbations are either mild, moderate, or severe according to changes in the neurological examination. One approach to measure severity of exacerbations is to use the Neurological Rating Scale (Sipe et al. (1984) Neurology 34:1368). An annual exacerbation rate and proportion of exacerbation-free patients are determined.

Therapy can be deemed to be effective using a clinical measure if there is a statistically significant difference in the rate or proportion of exacerbation-free or relapse-free patients between the treated group and the placebo group for either of these measurements. In addition, time to first exacerbation and exacerbation duration and severity may also be measured. A measure of effectiveness as therapy in this regard is a statistically significant difference in the time to first exacerbation or duration and severity in the treated group compared to control group. An exacerbation-free or relapse-free period of greater than one year, 18 months, or 24 months is particularly noteworthy. Clinical measurements include the relapse rate in one and two-year intervals, and a confirmed change in EDSS (as described above). On a Kaplan-Meier curve, a delay in sustained progression of disability shows efficacy. Other criteria include a change in area and volume of T2 images on MRI, and the number and volume of lesions determined by gadolinium enhanced images.

MRI can be used to measure active lesions using gadolinium-DTPA-enhanced imaging (McDonald et al., Ann. Neurol. 36:14, 1994) or the location and extent of lesions using T2-weighted techniques. Briefly, baseline MRIs are obtained. The same imaging plane and patient position are used for each subsequent study. Positioning and imaging sequences can be chosen to maximize lesion detection and facilitate lesion tracing. The same positioning and imaging sequences can be used on subsequent studies. The presence, location and extent of MS lesions can be determined by radiologists. Areas of lesions can be outlined and summed slice by slice for total lesion volume. Three analyses may be done: evidence of new lesions, rate of appearance of active lesions, and percentage change in lesion area (Paty et al., (1993) Neurology 43:665). Change in brain volume over time can also be measured. Improvement due to therapy can be established by a statistically significant improvement in an individual patient compared to baseline or in a treated group versus a placebo group.

Exemplary symptoms associated with multiple sclerosis, which can be treated with the methods described herein or managed using symptom management therapies, include: optic neuritis, diplopia, nystagmus, ocular dysmetria, internuclear opthalmoplegia, movement and sound phosphenes, afferent pupillary defect, paresis, monoparesis, paraparesis, hemiparesis, quadraparesis, plegia, paraplegia, hemiplegia, tetraplegia, quadraplegia, spasticity, dysarthria, muscle atrophy, spasms, cramps, hypotonia, clonus, myoclonus, myokymia, restless leg syndrome, footdrop, dysfunctional reflexes, paraesthesia, anaesthesia, neuralgia, neuropathic and neurogenic pain, L'hermitte's, proprioceptive dysfunction, trigeminal neuralgia, ataxia, intention tremor, dysmetria, vestibular ataxia, vertigo, speech ataxia, dystonia, dysdiadochokinesia, frequent micturation, bladder spasticity, flaccid bladder, detrusor-sphincter dyssynergia, erectile dysfunction, anorgasmy, frigidity, constipation, fecal urgency, fecal incontinence, depression, cognitive dysfunction, dementia, mood swings, emotional lability, euphoria, bipolar syndrome, anxiety, aphasia, dysphasia, fatigue, Uhthoffs symptom, gastroesophageal reflux, and sleeping disorders.

Each case of MS displays one of several patterns of presentation and subsequent course. Most commonly, MS first manifests itself as a series of attacks followed by complete or partial remissions as symptoms lessen, only to return later after a period of stability. This is called relapsing-remitting MS (RRMS).

Primary-progressive MS (PPMS) is characterized by a gradual clinical decline with no distinct remissions, although there may be temporary plateaus or minor relief from symptoms. It is characterized by a steady worsening of symptoms, and disability. PPMS makes up about 10% of MS diagnoses. Subjects with PPMS can experience relapses, but also experience symptoms that may occasionally speed up, slow down, or even get better for a time.

Secondary-progressive MS (SPMS) begins with a relapsing-remitting course followed by a later primary-progressive course. About 50% of the subjects with RRMS develop SPMS after about 15 years. It typically occurs gradually, usually within 10 years of initial diagnosis. While subjects with SPMS experience fewer relapses, their disability worsens and symptoms may become more pronounced. Rarely, patients may have a progressive-relapsing (PRMS) course in which the disease takes a progressive path punctuated by acute attacks.

Progressive-relapsing MS (PRMS) is characterized by steady worsening of disability along with occasional relapses. About 5% of the subjects with MS are diagnosed with PRMS.

PPMS, SPMS, and PRMS are sometimes classified together as progressive MS.

A few patients experience malignant MS, defined as a swift and relentless decline resulting in significant disability or even death shortly after disease onset. This decline may be arrested or decelerated by determining the likelihood of the patient to respond to a therapy early in the therapeutic regime and switching the patient to an agent that they have the highest likelihood of responding to. Some patients experience tumefactive MS, in which the first manifestation of MS is a tumor-like lesion in the brain.

### Expanded Disability Status Scale (EDSS) and the Evaluation of Progressive Forms of MS

The EDSS is a means to grade clinical impairment due to MS (Kurtzke et al. (1983) Neurology 33:1444). It is based on a standardized neurological examination, focusing on the signs that occur frequently in MS. Eight functional systems are evaluated for the type and severity of neurologic impairment by an expert clinician. Briefly, patients are evaluated for impairment in the following systems: pyramidal, cerebellar, brainstem, sensory, bowel and bladder, visual, cerebral, and other. Follow-ups are conducted at defined intervals. In addition, the EDSS also includes an assessment of long distance walking range. Based on the functional system scores and the walking range, an EDSS step is determined. The range of the EDSS includes 19 steps from 0 to 10, with EDSS step 0 corresponding to a completely normal examination and EDSS step 10 to death due to MS. A decrease of one full step indicates an effective treatment (Kurtzke et al., (1994) Ann. Neurol. 36:573-79), while an increase of one full step will indicate the progression or worsening of disease (e.g., exacerbation). For EDSS ratings between 0 and 4, the scale relies mainly on the scores of the individual FS. For ratings over 4, the EDSS is primarily determined by the ability and range of walking. Typically, patients having an EDSS score of about 4-6 will have moderate disability (e.g., walk with a cane), whereas patients having an EDSS score of about 7 or 8 will have severe disability (e.g., will require a wheelchair).

The EDSS has been useful in RRMS clinical research because it can capture changes across combinations of the 7 neurological systems in this population. However, this is not the case for progressive forms of MS, e.g., SPMS and PPMS (Cohen et al., (2002) Mult Scler 8(2): 142-154). For example, most of the patients enter SPMS clinical trials with baseline EDSS scores of 3.5 or higher, at which point progression is determined almost exclusively by large, threshold-based worsening of ambulation. Furthermore, over 50% of subjects enter SPMS clinical trials at EDSS steps of 6 or 6.5 where the EDSS is least responsive (FIG. 1B). As a result, the EDSS alone is inadequate to examine the therapeutic efficacy of drugs for progressive forms of MS. These limitations of the EDSS have been highlighted by several investigators over the last 20 years ((Ebers et al., (2008) Neurology 71: 624-63); (Wingerchuk et al. (1997) Mayo Clinic Proceedings 72: 1070-1079); (Noseworthy et al., (1994) Ann Neurol 36 Suppl: S80-85); Noseworthy et al. (1990) Neurology 40: 971-975).

The median baseline EDSS for patients enrolled in SPMS and PPMS clinical trials has been around 6. Therefore, the typical progressive MS patient enters therapeutic clinical trials able to walk independently less than 100-200 meters. In previous studies, nearly half of the patients examined at baseline already needed a cane to be able to walk 100 meters (48% in the IMPACT SPMS study and 42% in the rituximab PPMS OLYMPUS study) (Cohen et al. (2002) Neurology 59(5): 679-687; Hawker et al. (2009) Annals of Neurology 66(4): 460-471). Thus, the majority of patients enrolled in SPMS and PPMS clinical trials can be classified as progressors only if they lose at least 100-200 meters in ambulation (if baseline EDSS is 3.5-5), if they become dependent on a cane to walk at least 100 meters (baseline EDSS 5.5-6), or if they become dependent on a walker to walk as little as 5-20 meters (baseline EDSS 6.5-7) (Table 1). This contrasts with more recent research that has defined the minimally important change in ambulation in progressive MS as around 20 meters per year (Paltamaa et al. (2008) Phys Ther. 88(2):176-90). This indicates that the deterioration of ambulation needed to classify a subject as a progressor by EDSS is substantial and significantly in excess of what could be considered the minimally important clinical change.

TABLE 1
Loss of Ambulation required to be considered an EDSS “Progressor” for
MS patients who enter clinical trials with baseline EDSS scores between
3.5 and 6.5, inclusive.

| | Point | | Magnitude |
|---|---|---|---|
| Baseline | Change | Meaning | of |
| EDSS | Required | of the Loss of Ambulation | loss |
| 3.5 | 1.0 | Go from unrestricted ambulation | >200 m |
| | | to walk up to 300 m | |
| 4.0 | 1.0 | Go from walking 500 m to | 200 m |
| | | walking no more than 300 m | |
| 4.5 | 1.0 | Go from walking 300 m to walking | 200 m |
| | | no more than 100 m | |
| 5.0 | 1.0 | Go from walking 200 m | 100 m |
| | | independently to 100 m with | plus cane |
| | | a cane | |
| 5.5 | 1.0 | Go from walking 100 m | 80 m |
| | | independently to 20 m with walker | plus walker |
| 6.0 | 0.5 | Go from 100 m with cane to 20 m | 80 m |
| | | with walker | |
| 6.5 | 0.5 | Go from 20 m with walker to <5 m | >15 m |
| | | with walker | |

Thus, the EDSS alone is insufficient to investigate progressor status or therapeutic efficacy in progressive forms of MS due, at least in part, to: (1) a limited sensitivity in the higher EDSS range, e.g., 6-6.5; (2) a lack of responsiveness to worsening in non-ambulatory functions, and (3) problems inherent to the scale due to random variation, lack of linearity (FIG. 1B), and measurement errors (Ebers et al. (2008) supra). Additional clinical measures that supplement the sensitivity of this endpoint are required in order to adequately characterize progressive forms of MS and evaluate progressor status, as well as treatment effects on disease progression in progressive forms of MS.

### Use of T25FW and 9HP as Components of a Disease Progression Value

As highlighted above, in order to evaluate progressor status or show a beneficial effect of a treatment in preventing the progression of disability in MS, the endpoints selected must have adequate sensitivity to detect worsening disability in the studied population. In one embodiment, the combination of the T25FW and 9HP tests with the EDSS can be used to acquire a disease progression value. The disease progression value can be used for, e.g., in characterizing progressive forms of MS, evaluating progressor status, and evaluating the effectiveness of therapies in treating progressive forms of MS. Applicants' analysis of the placebo arm of the IMPACT SPMS study using a variety of definitions of progression revealed that only about 1 in 5 patients worsened on the EDSS total score (Table 2). The numbers were even lower for each of the EDSS system components considered individually when using the 2 points or greater threshold for meaningful change (range 3-11%, Table 2).

TABLE 2
Prevalence of Disability by EDSS System Involvement and Incidence of
Worsening After 2 Years in the Placebo Arm of the IMPACT Study
Percent of Patients by EDSS System Scores

| | | | | | | | Bowel | |
|---|---|---|---|---|---|---|---|---|
| | | | Brain | | | | & | Total |
| | Cerebral | Visual | Stem | Pyramidal | Sensory | Cerebellar | Bladder | EDSS |
| Baseline | 35.62% | 72.60% | 66.67% | 99.54% | 94.98% | 95.43% | 89.95% | 100.00% |
| ≧1 | | | | | | | | |
| ≧1 point | 18.46% | 29.74% | 21.54% | 21.65% | 20.51% | 30.41% | 28.72% | 20.21% |
| change | | | | | | | | |
| after 2 | | | | | | | | |
| years | | | | | | | | |
| ≧2 | 9.74% | 4.10% | 4.10% | 2.58% | 3.08% | 7.73% | 10.77% | 3.11% |
| points | | | | | | | | |
| change | | | | | | | | |
| after 2 | | | | | | | | |
| years | | | | | | | | |

The Impact Study was generally described in Cohen, 2002 Neurology 59(5):679-687.

By contrast, a consistent worsening from the baseline walk on the T25FW (in at least 6/8 post-baseline tests) was about 3 times more sensitive to disease progression, having occurred in 59% of subjects (Table 2). A similar high percentage of progressors was observed with the 9HP using the same definition (≧6/8 worse than baseline), 54%. Approximately 13% of subjects had confirmed worsening of upper extremity function as measured by the 9HP without concomitant worsening in ambulation as measured by the T25FW or the EDSS. Quantitative tests of motor function like the T25FW and 9HP have been used as exploratory outcome measures in MS clinical trials. Both the T25FW and the 9HP have been shown to have excellent inter- and intra-rater reliability (Solari et al. (2005)), and a responder analysis using the T25FW has precedence as a primary endpoint in a pivotal trial program (fampridine).

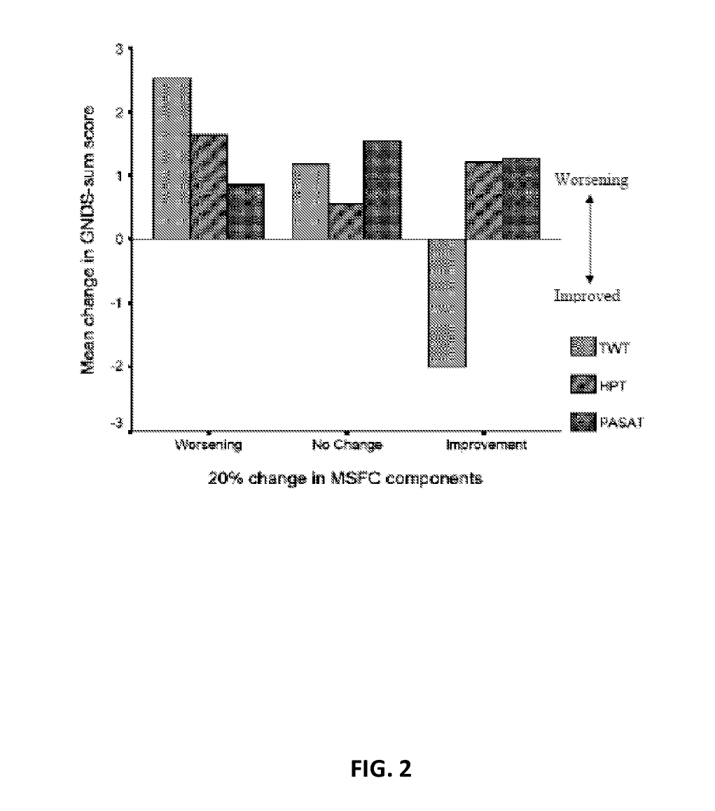

Several recent studies have argued that sustained worsening of at least 20% on either the T25FW or the 9HP may be clinically meaningful but provided limited data to support it (Schwid et al. (1997) Neurology 28: 817-821; Kaufman et al. (2000) Mult Scler 6(4): 286-290; Kragt et al. (2006) Multiple Sclerosis 12: 594-598); Kragt et al. (2006) Multiple Sclerosis 12: 782-786. One European longitudinal study of 527 MS patients using a patient reported anchor-based approach that measures patient-perceived daily life disability (Kragt et al. (2006) Multiple Sclerosis 12: 594-598), found that patients with at least a 20% increase in T25FW or 9HP had more worsening on the Guy's Neurological Disability Scale (GNDS) than patients without such increase (FIG. 2). The worsening of GNDS associated with an increase in T25FW was mainly due to an increase in perceived disability related to lower extremity function and fatigue, while GNDS worsening associated with an increase in 9HP was more diffuse with respect to the domains involved. The ‘20% or higher’ worsening in the T25FW or 9HP was also associated with changes in another robust parameter, the amount of help required from another person. It was concluded that worsening on T25FW or 9HP of at least 20% has a clinical impact on disability as perceived by MS patients during daily life functioning and as reflected by their increased need for assistance. A prospective North American study of MS patients experiencing exacerbations arrived to similar conclusions about the T25FW (Kaufman et al. (2000) Mult Scler 6(4): 286-290): patients who complained of difficulty walking, but who did not have changes otherwise detectable by examination, generally had a prolongation of walk time of at least 20%. The relevance of the 9HP as a valid measure of upper extremity function is supported by validated patient reported instruments of upper extremity function like DASH (disability of the arm, shoulder, and hand) and objective testing by electrophysiology (Yozbatiran et al. (2006) J Neurol Sci. 246: 117-22; Nociti et al. (2008) J Neurol Sci 273: 99-102; Padua et al (2007) J Neurol Sci. 253:106[a1]).

These results support the conclusion that the disease progression value disclosed herein, which includes confirmed progression of at least 20% on the T25FW and/or the 9HP, represent measures of clinically meaningful progression in physical disability. Additionally, the T25FW and 9HP tests have been shown to be sensitive measures to detect progression of disability in patients with progressive forms of MS, and an increase of at least 20% in these endpoints has been shown to be clinically meaningful.

### Disease Progression Value

The disease progression value disclosed herein can be used as a means to confirm progression or non-progression in MS patients. This can be used in MS patient evaluation and as a primary endpoint for use in clinical trials, as well as in the evaluation of the effects of a treatment in preventing the progression of disability in the clinic. The disease progression value can include individual component parameters of the T25FW, the 5- or 6-minute walk (e.g., 6MWT), the 9HP, and/or the EDSS.

In certain embodiments, progressors are defined as patients who possess a disease progression value reflecting at least one, two, or three of the following criteria:
a. confirmed progression in EDSS:
(i) EDSS total score increase from baseline by at least 1 point, if the change in EDSS total score is determined (or primarily determined) by evaluating a change in neurological function (e.g., one or more changes in neurological systems),
(ii) EDSS total score increased from baseline by at least 0.5 point, if the change in EDSS total score is determined (or primarily determined) by a change in ambulatory function,
wherein the change in a.(i) or a.(ii) is confirmed at a second time point at least 3, 4, 5 or 6 months apart;
b. confirmed progression in T25FW: Time taken for 25-foot walk increased by at least 20% of the baseline walk, confirmed at a second time point at least 6 months apart; and/or
c. confirmed progression in 9HP: Time taken for 9-hole peg increased by at least 20% of the time taken at baseline, confirmed at a second time point at least 3, 4, 5 or 6 months apart. The progression in 9HP can occur on either hand, but will have to be confirmed on the same hand.

This proposed disease progression value includes EDSS, which is consistent with scientific and regulatory precedent, but also includes measures with improved sensitivity to detect clinically meaningful changes in upper extremity (9HP) and lower extremity or ambulatory (T25FW or 5- or 6-min walk test) function, where EDSS alone may not be appropriately responsive.

Baseline values for the aforementioned tests (e.g., T25FW, 5- or 6-min walk test, EDSS, or 9HP) can be determined using the best baseline value or the average baseline value.

The responsiveness of the EDSS to disease progression for patients entering progressive MS clinical trials, e.g., SPMS trials (baseline score 3-6.5), varies markedly depending on whether they are in the lower (3-5.5) or upper (6-6.5) EDSS range (FIG. 1B). In the upper range (6-6.5), large, threshold-based changes in ambulatory capacity are needed to classify a subject as a progressor (Table 1). On the other hand, T25FW is a measure of quantitative ambulatory capacity over a short distance that is responsive to deterioration mostly for subjects who are disabled and enter the trial at EDSS steps 6-6.5 (FIG. 1A). In addition, 9HP is a quantitative measure that captures a clinically important aspect of upper extremity function that is not measured by the EDSS or the T25FW. Unlike the EDSS and the T25FW, the 9HP is responsive across a wide EDSS range (FIG. 1C). Therefore, the use of three measures in the primary outcome covering both upper and lower extremity functions that are responsive across a wide range of disability provides a comprehensive assessment tool of treatment effects on clinically meaningful progression of physical disability over years (FIG. 1D).

In the setting of a clinical trial or other patient evaluation, a possible progression begins when the defined minimum change (Table 3) is reached. Progression can be confirmed, if the first visit at least 3, 4, 5 or 6 months after the visit with a possible progression also satisfies the defined minimum change. If the value at the subsequent visit does not reach the defined minimum change, the progression may not be confirmed. To identify a possible progression, all study visits (except unscheduled visits for relapse assessments) may be used. For the purpose of confirming a progression, only scheduled study visits including the follow-up visit and the early withdrawal visits may be used.

TABLE 3
Minimum criteria for change to meet the disability progression in the
disease progression value.

| Parameter | Minimum Change from Baseline (any 1 or more) |
|---|---|
| EDSS | ≧1 point increase from baseline EDSS ≦5.5 |
| | ≧0.5 point increase from baseline EDSS ≧6.0 |
| T25FW | ≧20% increase |
| 9HP | ≧20% increase |

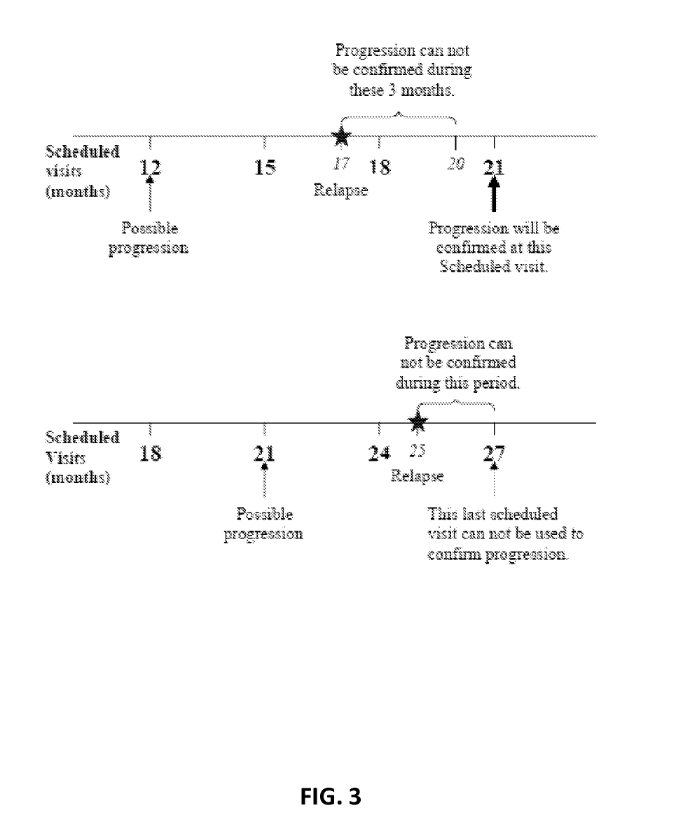

To minimize the possibility of capturing disability progression due to clinical relapses, a possible progression may not be started nor confirmed at a visit in the 3 months following onset of a clinical relapse. If a clinical relapse occurs within 6 months following a possible progression, the progression may have to be confirmed at the first visit at least 3 months after the relapse (FIG. 3). This strategy is supported by the observation that the majority of recovery following an MS relapse occurs in the first 3 months (Iuliano et al. (2008) Eur Neurol 59(1-2): 44-48). If the only visit after a possible progression occurs during the 3 months after a clinical relapse, then the progression may not be confirmed.

In conducting patient evaluation, e.g., in a medical setting or a clinical trial, for each parameter of the disease progression value, if a subject does not have a baseline assessment for the parameter, then the median value for a patient population (e.g., from the study population if in the context of the clinical trial) can be used for the subject. In some embodiments, the baseline is defined as the closest non-missing value prior to the first infusion of study drug. If a subject does not have any post-baseline assessment of the parameter, the subject can be considered as a confirmed progressor in the primary analysis. As a sensitivity analysis, subjects who do not have any baseline or post-baseline assessments of a parameter can be excluded from the analysis of that parameter.

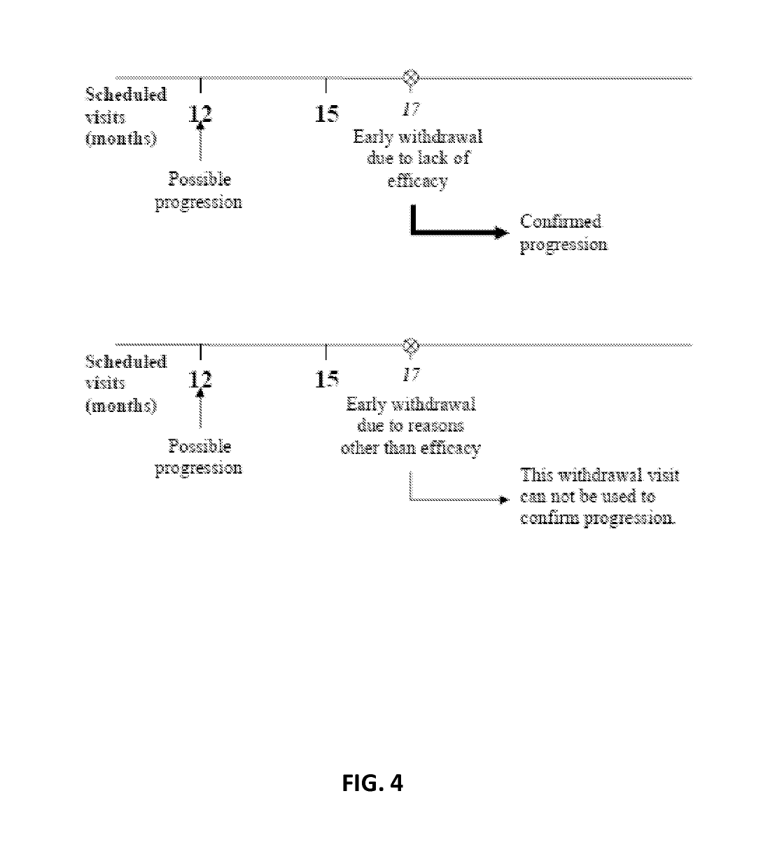

A subject who misses one or more visits that are preceded and followed by visits at which the evaluations satisfy the defined minimum change criteria for disability progression can be considered as a confirmed progressor. For subjects who have a possible progression but withdraw from evaluation (e.g., a clinical study) prematurely before the progression can be confirmed, if the withdrawal is due to lack of efficacy, the progression can be considered as a confirmed progression (FIG. 4). Otherwise, the subjects can not be considered as confirmed progressors. Disability progression can be confirmed at the premature withdrawal visit, as long as the premature withdrawal visit is at least 6 months after the possible progression to be confirmed, and does not occur during the 3 months following a relapse.

Subjects who have a possible progression, but do not have a subsequent visit at least 6 months after the possible progression to confirm the progression may not be considered as confirmed progressors. Death due to MS, as determined by a physician or clinical investigator, may be counted as a confirmed progression. In a clinical trial setting, the percentage of confirmed progressors can be presented by treatment group, with the treatment comparison analyzed by logistic regression. The model to be used can be defined in advance. The percentage of confirmed progressors in each of EDSS, T25FW, and 9HP can also be presented with treatment comparisons by logistic regression. The disease progression value as described herein can be analyzed for subjects with and without a clinical relapse. Time to confirmed progression can also be analyzed using Cox proportional hazards model

### Ambulatory Assessments

### T25FW

The T25FW, also referred to as a “timed walk of 25 feet” is a measure of quantitative ambulatory capacity over a short distance that is responsive to deterioration mostly for subjects who are very disabled, e.g., EDSS steps 6-6.5. It is used as quantitative measure of lower extremity function. Briefly, the subject is directed to one end of a clearly labeled 25-foot course and is instructed to walk 25 feet as quickly as possible, but safely. The task is immediately administered again by having the subject walk back the same distance. Subjects may use assistive devices when completing the T25W. A time limit of 3 minutes to complete the test is usually used. The test is discontinued if the subject cannot complete Trial 2 of the T25W after a 5 minute rest period, or if the subject cannot complete a trial in 3 minutes.

### 9HP

The 9HP, also referred to as a “9-hole peg” test is a quantitative measure that captures a clinically important aspect of upper extremity (e.g., arm and hand) function that is not measured by the EDSS or the T25FW. Unlike the EDSS and the T25FW, the 9HP is responsive across a wide EDSS range. Briefly, a subject is asked to pick up 9 pegs one at a time, using his or her hands only, and put the pegs into the holes on a peg board as quickly as possible until all of the holes are filled. The subject must then, without pausing, remove the pegs one at a time and return them to the container as quickly as possible. Both the dominant and non-dominant hands are tested twice (two consecutive trials of the dominant hand, followed immediately by two consecutive trials of the non-dominant hand). A time limit of 5 minutes to complete the test is usually used. The test is discontinued if the subject cannot complete one trial of the 9HP test in 5 minutes; if the subject cannot complete a trial with his or her dominant hand within 5 minutes, the subject is usually instructed to move onto the trials with the non-dominant hand.

### Timed Walk Test

A timed walk test, e.g., a 5-, or more typically, a 6-minute walk test (6MWT) is often used to assess walking distance in MS. The test measures the distance an individual is able to walk over a total of a preselected timed interval (e.g., five or six minutes) on a hard, flat surface. The goal is for the individual to walk as far as possible during the timed interval (e.g., in five or six minutes). The individual is allowed to self-pace and rest as needed as they traverse back and forth along a marked walkway. Variations of this test include shorter or longer walking distances are also contemplated in the longer distance ambulatory function. See for example, Gijbels, D. et al. (2011) Mult Scler 17(10):1269-72, describing a 2-minute walk test (2MWT).

### Patient Reported Outcome Assessments

Exemplary additional ambulatory tests that can be used in combination with the tests described herein include but are not limited to the following.

### MSWS-12

The Multiple Sclerosis Walking Scale-12 (MSWS-12) test is a self rated measure of walking ability (Holland, A. et al. (2006) J Neurol. 253(12):1594-602). The test contains 12 questions with Likert-type responses, describing the impact of MS on walking. The questions were generated from MS patient interviews, expert opinions, and literature reviews (Table 4).

TABLE 4
Impact of MS on physical function in the preceding 2-4 weeks.
Comparison of the patient reported items from the MSWS-12 and
MSIS-29 physical.

| | Item Number of Scale^{a} | |
|---|---|---|
| | | MSIS-29 |
| MSWS-12 Wording | MSWS-12 | Physical |
| Ability to walk | 1 | |
| Ability to run | 2 | |
| Ability to climb up/down | 3 | |
| Standing while doing things | 4 | |
| Balance standing/walking | 5 | |
| How far can you walk | 6 | |
| Effort needed to walk | 7 | |
| Need for support walking indoors | 8 | 5 |
| Need for support walking outdoors | 9 | |
| Speed of walking | 10 | |
| Smoothness of walking | 11 | 4 |
| Need to concentrate during walk | 12 | |
| Do physically demanding tasks | | 1 |
| Grip things tightly | | 2 |
| Carry things | | 3 |
| Being clumsy | | 6 |
| Stiffness | | 7 |
| Heavy arms and or legs | | 8 |
| Tremor of arms or legs | | 9 |
| Limb spasms | | 10 |
| Body not doing what you want it to do | | 11 |
| Dependence on other to do things for you | | 12 |
| Limitation on home leisure/social activities | | 13 |
| Being stuck at home more than you would like | | 14 |
| Difficulty using hands | | 15 |
| Need to reduce time spent on work or ADLs | | 16 |
| Problems using transport | | 17 |
| Taking longer to do things | | 18 |
| Difficulty doing things spontaneously | | 19 |
| Needing to go to the toilet urgently | | 20 |

^{a}Numbers correspond to their location within the actual assessment scale.

### ABILHAND 56-Item Questionnaire

The ABILHAND 56-Item Questionnaire is a measure of manual ability designed to measure a patient's experience of problems in performing everyday manual tasks such as feeding, dressing, or managing chores (Penta M. et al. (1998) Arch Phys Med Rehabil. 79:1038-1042). The ABILHAND contains 56 unbiased questions about bimanual activities, which the patients are asked to judge on a four-level scale: 0=impossible, 1=very difficult, 2=difficult, 3=easy.

### MSIS-29

The Multiple Sclerosis Impact Scale 29 (MSIS-29) is a 29 item self report rating scale which measures physical (20 items) and psychological (9 items) parameters of MS (Hobart, J. et al. (2001) Brain 124 (5): 962-973). Three of the items deal with limited abilities, and the remaining 26 items are related to patients being impacted by MS related symptoms or consequences disease (Table 4). Responses use a 5 point Likert scale range from 1 to 5.

### SF-36

The short form 36 (SF-36) test measures overall health related quality of life (Hobart, J. et al. (2001) J Neurol Neurosurg Psychiatry 71:363-370). The SF-36 is a structured, self report questionnaire that the patient can generally complete with little to no intervention from a physician. There is no single overall score for the SF-36, instead it generates 8 subscales and two summary scores. The 8 subscales include physical functioning, role limitations due to physical problems, bodily pain, general health perceptions, vitality, social functioning, role limitations due to emotional problems, and mental health. The two summary scores include a physical component summary and a mental health component summary.

### Cognitive Test Assessments

Several cognitive test instruments can be used, in combination with the tests described herein, to evaluate the subjects overall level of disability and impairment (both physical and cognitive). Exemplary cognitive tests that can be used include one or more of the following.

### Symbol Digit Modalities Test (SDMT)

The SDMT is a test that evaluates processing speed and working memory in which the subject is given 90 seconds to pair specific numbers with given geometric figures based on a reference key. It is modeled after the Digit Symbol or Coding Tasks tests, which have been included in the Wechsler intelligence scales for many years (e.g., Wechsler et al. (1974) Manual for the Wechsler Intelligence Scale for Children—Revised. New York: Psychological Corporation; Wechsler et al. (1981) WAIS-R Manual. New York: Psychological Corporation). Recognizing the limitations some patients have with manual dexterity, Rao and colleagues modified the SDMT to include only an oral response for use in MS (Rao et al. (1991) Neurology 41: 685-691). In this oral SDMT selected in the present invention, participants are presented with an 8.5×11 inch sheet that contains the numbers and symbols to be processed. The top row of stimuli includes nine symbols, each of which is paired with a single digit in the key. The remainder of the page has a pseudo-randomized sequence of these symbols, and the participant's task is to respond orally with the digit associated with each of the symbols as quickly as possible. The score is the total number of correct matches (out of 110) made by the subject within the 90 second time frame.

Good test-retest reliability (r=0.93-0.97, p<0.001) has been established in MS subjects (Benedict et al. (2006) Journal of the International Neuropsychological Society 12: 549-558; Benedict et al. (2008) Multiple Sclerosis 14: 940-946). Good discriminative validity for distinguishing between MS patients and normal controls (d=1.0-1.5, p<0.001) (see e.g., Deloire et al. (2005) Journal of Neurology, Neurosurgery & Psychiatry 76: 519-526; Benedict et al. (2006) Journal of the International Neuropsychological Society 12: 549-558; Houtchens et al. (2007) Neurology 69: 113-123; Strober et al. (2009) Multiple Sclerosis 15: 1077-1084; Parmenter et al. (2010) J Int Neuropsychol Soc 16: 6-16) and for distinguishing between RRMS and SPMS patients (d=0.8, p<0.001) (see Benedict et al. (2006) Archives of Neurology 63: 1301-1306) has also been confirmed. In addition, correlations between performance and brain MRI have also been documented (see e.g., Benedict et al. (2007) Multiple Sclerosis 13: 722-730; Houtchens et al. (2007) Neurology 69: 113-123; Tekok-Kilic et al. (2007) NeuroImage 36: 1294-1300). Alternate forms for the SDMT are available (Reliability and equivalence of alternate forms for the Symbol Digit Modalities Test: implications for multiple sclerosis clinical trials. Benedict R H, Smerbeck A, Parikh R, Rodgers J, Cadavid D, Erlanger D. Mult Scler. 2012 Jan. 25).

### Paced Serial Addition Test (PASAT)

First developed by Gronwall et al. to assess patients recovering from concussion, the PASAT requires patients to monitor a series of 61 digits while adding each consecutive digit to the one immediately preceding it (Gronwall et al. (1977) Perceptual and Motor Skills 44: 367-373). The digit series can be provided in audio form (e.g., audiotaped) or any other form such as CD or DVD. The PASAT requires both rapid information processing and simultaneous allocation of attention to two tasks, as well as reasonably intact calculation ability. In its original format, the PASAT was administered at four inter-stimulus intervals (2.4 seconds, 2.0 seconds, 1.6 seconds, and 1.2 seconds). The number of inter-stimulus intervals and presentation rates were subsequently modified by Rao and colleagues for use with MS patients to 3.0 seconds and 2.0 seconds (Rao et al. (1991) A Manual for the Brief, Repeatable Battery of Neuropsychological Tests in Multiple Sclerosis: National Multiple Sclerosis Society; Rao et al. (1991) Neuropsychological Screening Battery for Multiple Sclerosis: National Multiple Sclerosis Society; Rao et al. (1991) Neurology 41: 685-691; Rao et al. (1991) Neurology 41: 692-696).

This latter version of the test was selected to be a component of the MS Functional Composite and the MACFIMS battery (Benedict et al. (2002) Clinical Neuropsychologist 16: 381-397). Test-retest reliability in MS populations ranges from r=0.78 to 0.93 (Benedict et al. (2006) Journal of the International Neuropsychological Society 16: 228-237; Drake et al. (2010) Multiple Sclerosis 16: 228-237). Good discriminative validity for distinguishing between MS patients and normal controls (d=0.5-0.7, p<0.001 to 0.34) (Deloire et al. (2005) Journal of Neurology, Neurosurgery & Psychiatry 76: 519-526; Benedict et al. (2006) Journal of the International Neuropsychological Society 12: 549-558; Houtchens et al. (2007) Neurology 69: 113-123; Strober et al. (2009) Multiple Sclerosis 15: 1077-1084; Parmenter et al. (2010) J Int Neuropsychol Soc 16: 6-16; Drake et al. (2010) Multiple Sclerosis 16: 228-237) and for distinguishing between RRMS and SPMS patients (d=0.5, p<0.002) (Benedict et al. (2006) Archives of Neurology 63: 1301-1306) has been confirmed. The PASAT score of interest is the total number of correct responses at each presentation rate. Two alternate forms of the Rao version of the PASAT are available (PASAT 3″ and PASAT 2″) and were selected in the current invention. In the PASAT 3″, the stimulus is presented every 3 seconds, where as in the PASAT 2″, the stimulus is presented every 2 seconds.

### Selective Reminding Test (SRT)

The SRT was first developed by Buschke et al. (see Buschke et al. (1974) Neurology 24: 1019-1025) who conducted research in the area of anterograde amnesia. Rather than ask patients to recall an entire word list on each successive learning trial, the experimenter only repeated words not recalled on each successive learning trial. Subsequently, several memory investigators developed normative data for the test, and alternate forms. The original versions were based on a form of the test using 15 words and 12 learning trials. Such an administration is arduous and time consuming, and therefore there has been much interest in shorter forms of the SRT. The administration procedure widely used in MS research is a six-trial form developed by Rao et al. (see e.g., Rao et al. (1991) A Manual for the Brief, Repeatable Battery of Neuropsychological Tests in Multiple Sclerosis: National Multiple Sclerosis Society; Rao et al. (1991) Neuropsychological Screening Battery for Multiple Sclerosis: National Multiple Sclerosis Society; Rao et al. (1991) Neurology 41: 685-691; Rao et al. (1991) Neurology 41: 692-696). This six-trial format is utilized in the current invention. A number of different versions of SRT word lists exist. Hannay and Levin's word lists for adults, test forms 1 and 3, are utilized in the current invention (Hannay et al. (1985) J Clin Exp Neuropsychol. 7: 251-263). Discriminative validity of the SRT has been established in several studies, with SRT discriminating between MS subjects and normal controls d=0.6 to d=1.0 (see e.g., Rao et al. (1991) A Manual for the Brief, Repeatable Battery of Neuropsychological Tests in Multiple Sclerosis: National Multiple Sclerosis Society; Deloire et al. (2005) Journal of Neurology, Neurosurgery & Psychiatry 76: 519-526; Strober et al. (2009) Multiple Sclerosis 15: 1077-1084). It has also been shown that SRT findings correlate with ventricular enlargement as seen on brain MRI (R²=0.14; p=0.05) (Christodoulou et al. (2003) Neurology 60: 1793-1798).

### Brief Visuospatial Memory Test-Revised (BVMT-R)

The BVMT-R is based on an initial effort to develop an equivalent alternate form visual memory test along the lines of the visual reproduction subtest from the Wechsler Memory Scale (Benedict et al. (1993) Neuropsychological Rehabilitation 3: 37-51; Benedict et al. (1995) Clinical Neuropsychologist 9: 11-16; Wechsler et al. (1987) Wechsler Memory Scale-Revised Manual. New York: Psychological Corporation). Initially, the BVMT included just a single exposure to a one-page presentation of six visual designs. The revised version includes three 10-second exposures to the stimulus (Benedict et al. (1997) Brief Visuospatial Memory Test—Revised: Professional Manual. Odessa, Fla.: Psychological Assessment Resources, Inc.; Benedict et al. (1996) Psychological Assessment 8: 145-153). After each exposure, the subject is asked to reproduce the matrix using a pencil on a blank sheet of paper. There are rigid scoring criteria for accuracy and location. After a 25 minute delay, the patient is asked to reproduce the information again without another exposure. Finally a yes/no recognition task is presented. The BVMT-R has excellent reproducibility, with test-retest reliability ranging from r=0.85 to r=0.91 (Benedict et al. (1996) Psychological Assessment 8: 145-153; Benedict et al. (2005) Journal of the International Neuropsychological Society 11: 727-736); as well as good discriminative validity between MS and normal control subjects (d=0.9, p<0.) (Strober et al. (2009) Multiple Sclerosis 15: 1077-1084; Parmenter et al. (2010) J Int Neuropsychol Soc 16: 6-16) and RRMS and SPMS patients (d=0.6, p<0.001) (Benedict et al. (2006) Archives of Neurology 63: 1301-1306). Predictive validity, in the form of correlation between BVMT-R performance and brain MRI findings, has also been established (Stankiewicz, J. M. et al. (2011) J. Neuroimaging April; 21(2):e50-6. doi: 10.1111/j.1552-6569.2009.00449.x). Further, there is extensive research showing that all 6 forms of the test are of equivalent difficulty. Variables of interest in the current invention are the Total Learning and Delayed Recall scores.

### Scoring Consistency and Evaluation

Calculating an assessment score consistently and accurately is an important aspect of evaluating a subject's disease status or progression. EDSS testing can be difficult for individual physicians to administer consistently. In some implementations, EDSS certification can be made a pre-requisite before allowing an evaluator (e.g., a physician) to perform the EDSS testing. Scoring certification can be required on any selected evaluation methodology to help insure consistent scoring of patient assessments.

In one implementation, an evaluator can have valid Neurostatus Level C certification (i.e., at least 38/50 (76% correct or higher) score on the Neurostatus Exam). Passing scores can be accepted if the scores were achieved within the last 24 months prior to test administration. Requirements can include certification of specific forms of EDSS Training. In some examples, certification testing can be administered on-line via web based applications. Certifications can be required for EDSS training approaches that are specific to a given study.

It is realized that there is a need to optimize consistency of the EDSS assessments, both on data gathering and the calculation of assessment scores from gathered data. Additionally, there is a need to deal with multiple iterations of existing scoring methodologies, including, for example, EDSS (e.g., Kurtzke's 1983), EDSS plus, and multiple versions of Neurostatus (e.g. 2009, 2011). Accordingly, provided are scoring systems for facilitating data collection and calculation of resulting assessment values. In some embodiments, the system executes functions for analyzing data inputs. The analysis functions can be configured to limit data collection errors (e.g., ensuring valid inputs, highlighting unexpected values for confirmation, highlighting inconsistent values for confirmation). In further embodiments, the system limits some scoring approaches to selection of one or more detailed categories. In some examples, eliminating the need for an evaluator to select a numeric score based on memorized rules in favor of detailed categories improves scoring consistency. In further examples, category selection over value assignment can also eliminate interpretation error. By insuring consistency in scoring, various embodiments of the scoring systems insure valid data is being entered and evaluated. Additionally, various embodiments provide an opportunity to learn from previous tests based on the assurance of consistent application of scoring rules.

According to one aspect, EDSS scoring suffers from a number of problems in achieving consistency. In one example, the calculation of a combined assessment score can be complex, involving the combination of individual scores for 7 EDSS functional systems (“FS”) (e.g., visual, brainstem, cerebellar, motor, sensory, bladder/bowel, and cognitive). Other example assessments include the FS values modified by an ambulation scoring (e.g., scoring on the distance walked with/without aids in the 500 m walk).

Further complicating the determination of a complex assessment score is the potential for execution at separate sites in multiple countries. In such settings, any inconsistency in scoring can result in an improper treatment or therapy. Further, in such settings language and interpretation pose significant barriers to achieving consistency.

It is further realized that common sources of error in EDSS scoring in MS clinical settings include the inconsistent use of the scoring rules by evaluators. Additionally, there are also transcription errors and inattention errors that skew results. For example, evaluation of actual assessments performed demonstrate inconsistencies between a reported EDSS score and the underlying scoring given to the EDSS functional system and Ambulation scores used to generated the reported EDSS score.

In one example, shown in Table 5 reported EDSS scores are inconsistent with the scoring rules of the EDSS assessment. Such mistakes are unlikely to have come from the scoring physician but rather may result from transcription errors or inattention.

TABLE 5

| EDSS Functional | | Reported | |
|---|---|---|---|
| System Score | Ambulation | EDSS | Comments |
| all 7 FS have Grade | Unrestricted | 2.5 | EDSS |
| 0 | ambulatory | | Should be |
| | | | 0; |
| Three Grade 1 and | Unrestricted | 3.5 | EDSS |
| all other Grade 0 | ambulatory | | Should be |
| | | | 1.5; |

Table 6 illustrates further examples of common mistakes in reported EDSS compared to a system calculated score (for example, where the reported score should not be lower than the maximal score of all single FS scores).

TABLE 6

| | | Reported | |
|---|---|---|---|
| EDSS Functional System Score | Ambulation | EDSS | Comments |
| One Grade 3 and six Grade 0 | Unrestricted | 2 | EDSS |
| | ambulatory | | should be |
| | | | 3.0; |
| One Grade 4, no grade 3, no Grade | Unrestricted | 3 | EDSS |
| 2, others Grade 0/1 | ambulatory | | should be |
| | | | 4.0 |
| One Grade 4, some Grade 2, others | Unrestricted | 3.5 | EDSS |
| Grade 0/1 | ambulatory | | should be |
| | | | 4.5 |

Shown below in Table 7 are further examples of inconsistency in EDSS scoring. For example, in row 1—although according to Kurtzke (1983), this case may be EDSS of 1.5, according to Neurostatus ((2009 and 2011) because the ambulation is fully ambulatory but not unrestricted) the EDSS score is at least 2.0. In rows 2-3, the ambulation scores were not considered when EDSS total scores were determined (which can be, for example, a physician scoring error). Furthermore, if the ambulation is so impaired, the FS scores (Pyramidal, Cerebral and sensory) are expected to be more severe than reported. According to some embodiments, system analysis of the input data (e.g., ambulation vs. FS scores) can be configured to detect deviation between expected values for input Pyramidal, Cerebral and sensory FS scores and the ambulation score and present notifications to the evaluator to confirm their analysis.

In rows 4-8, the same FS scores with different ambulation scores can have significantly different EDSS results. It is realized that measuring the distance walked consistently impacts resulting assessment scores. In some embodiments, the system is configured to require evaluators to select from detailed ambulation categories from which the system is configured to assign an ambulation value. Selection of detailed categories has been observed to limit inconsistency. In some examples, selection of detailed categories can limit inconsistency even where the categories are presented or translated into multiple languages.

In rows 9-10, because of prominent impairment in both FS scores and ambulation scores, evaluators can have difficulty determining the total EDSS scores—both Kurtzke (1983) and Neurostatus are not precisely defined for these steps. However system defined criteria, implemented in various embodiments, can be pre-specified to calculate assessment scores even where other tests are imprecise. For example, various embodiments include detailed scoring rules which are executed to derive consistent output.

In rows 11-12, visual and bowel and bladder FS scores are being entered based on unconverted values. Prior versions of approved tests have employed different scoring regimes. In some embodiments, the system can evaluate input data at entry to insure that invalid and/or out of range values are flagged for review (e.g., out of range values can be an artifact of prior scoring regimes). In some examples, the system can prevent entry of data outside of a defined data range. In rows, 11-12, the FS scores for visual and bowel and bladder must be converted from before an EDSS total score is determined.

TABLE 7

| | EDSS Functional | | Reported | |
|---|---|---|---|---|
| Row | System Score | Ambulation | EDSS | Comments |
| 1 | Five Grade 1 and | 500 meters without | 1 (or 1.5) | EDSS should be |
| | two Grade 0 | aid or rest | | 2.0; |
| 2 | One Grade 2, | 100 meters with | 2 | EDSS Should be |
| | multiple Grade 1, | unilateral | | 6.0 regardless of |
| | others all Grade 0 | assistance | | FS scores; |
| 3 | Two Grade 1, others | >=100 meters and | 2 | EDSS should be |
| | all Grade 0 | <200 meters | | 5.5 |
| | | without aid or rest | | |
| 4 | One Grade 3, two | 500 meters without | 6 | EDSS Should be |
| | Grade 2, three Grade | aid or rest | | 3.5; |
| | 1 and one Grade 0 | | | |
| 5 | One Grade 3, two | 480 meters without | | EDSS Should be |
| | Grade 2, three Grade | aid or rest | | 4.5 |
| | 1 and one Grade 0 | | | |
| 6 | One Grade 4, three | 200 meters without | 6.5 | EDSS Should be |
| | Grade 3, one Grade 2 | aid or rest | | 5.5 |
| | and two Grade 1 | | | |
| 7 | One Grade 4, three | 180 meters without | | EDSS is still 5.5 |
| | Grade 3, one Grade 2 | aid or rest | | |
| | and two Grade 1 | | | |
| 8 | One Grade 4, three | 300 meters without | | EDSS should be |
| | Grade 3, one Grade 2 | aid or rest | | 5.0 |
| | and two Grade 1 | | | |
| 9 | One Grade 4, no | >=200 meters and | 4 | EDSS is 5.0 |
| | Grade 3, all other | <300 meters | | |
| | Grade 0/1/2 | without aid or rest | | |
| 10 | One Grade 4, >=1 | >=200 meters and | 5 | EDSS is 5.5 |
| | Grade 3 or >=2 | <300 meters | | |
| | Grade 4 | without aid or rest | | |
| 11 | Visual FS = 6, all | Unrestricted | 4 | This Visual FS |
| | other Grade 0 | ambulatory | | score should be |
| | | | | converted to 4 |
| 12 | Bowel and Bladder | >=500 meters | 5 | This |
| | FS = 6, three Grade | without aid or rest | | Bowel/Bladder |
| | 2, one Grade 1 and two | | | FS score should be |
| | Grade 0 | | | converted to 5 |

In various embodiments, transcribed scores (i.e., scores not computed by the system) can be evaluated for consistency and boundaries at input. In some examples, the system can be configured to prevent input of unconverted scores. In further embodiments, the system can provide real time feedback, regarding input values. In one example, the system can generate notifications and/or displays regarding potential errors as evaluators input data (e.g., “input exceeds bounds—considered converted value”, “FS and ambulation scores inconsistent—please verify”, among other options). According to some embodiments, the system can include a user interface configured to generate and provide notifications responsive to input data.

According to another aspect, various computer implementation of scoring systems can include pre-defined categorizations for evaluator selection. In some embodiments, rather than let an evaluator (e.g., a physician) assign a score for a patient's assessment, the system can be configured to provide categories for selection. In one embodiment, ambulation scoring used in conjunction with EDSS functional system scores is presented to an evaluator as categorical selections. The system includes associations between the presented categories and numerical scores. By requiring that evaluators select categories rather than generate numerical assignment, the system enables improvements in consistency.

According to some embodiments, evaluators can interact with user interface displays to enter EDSS functional system scores. In conjunction with entry of FS scores evaluators can be prompted to select a description characterizing the patient's ambulation within the user interface. In one example, the descriptions are presented in a user interface configured to accept a single selection. Once the underlying values are input and the category selected, the system automatically calculates the total EDSS score, combining individual scores from the 7 functional systems with the ambulation score associated with the selected ambulation category. In some implementations, the system can also be configured to analyze the FS scores and the selected ambulation category to determine if the entered values are consistent. For example, the system can be configured to analyze existing data to determine if newly entered data exceeds a defined deviation. If, in one example, ambulation is impaired (e.g., >6), the associated FS scores for a patient should also reflect some impairment. Values for the associated FS can be flagged for review by the system and/or the selected category can be highlighted for additional review.

According to one aspect, system execution of scoring rules guaranties consistent implementation of assessment scoring. Further, system based execution of the scoring rules guaranties consistency over conventional approaches, which permit evaluators to calculate the combination of the individual scoring elements. As discussed, the system can also execute evaluations of input information against the scoring rules and/or expected results to identify and/or highlight values that do not conform to expectations. In other embodiments, evaluators can still enter their own calculation for a combined score. In such embodiments, the system can also confirm evaluator based scoring to insure accuracy. In some examples, the system can be configured to flag values that are not consistent between entered scores and system calculated scorings. According to one embodiment, scores that deviate from expected and/or calculated values can still be used. For example, the system can be configured to prompt a user to confirm a suspect value. Upon confirmation, the suspect value is accepted by the system even if the system calculated value is different.

It is appreciated that system based analysis of EDSS scores captures consistency and/or alignment of execution for EDSS scoring rules. Automating the execution of scoring methodologies (and limiting expert evaluator calculations) can improve consistency. Further, automating scoring methodologies generates additional advantages in error control. For example, system based execution can screen out potential transcription or inattention errors and yield uniformity on interpretation of scoring rules. The use of descriptive categories to assess ambulation results in improved consistency and/or reduction of interpretation errors in scoring.

### Scoring Ambulation and Combining Scores

Various embodiments of scoring systems include scoring of ambulation as part of a patient assessment. According to one aspect, categorization of ambulation provides improvements in consistency of scoring, increases alignment in scoring between different locations (even across language barriers), and/or improves uniformity in interpretation of scoring rules.

According to one embodiment, ambulation categories include one or more (or all) of the following:
0=Unrestricted ambulation (able to walk a distance that is regarded as normal, compared with healthy individuals) without aid or rest;
1=>=500 METERS without aid or rest;
2=>=300 METERS AND <500 METERS without aid or rest;
3=>=200 METERS AND <300 METERS without aid or rest;
4=>=100 METERS AND <200 METERS without aid or rest;
5=<100 METERS without aid or rest;
6=Unilateral assistance required: Able to walk more than 50 meters with one stick, crutch or brace;
7=Unilateral assistance required: Cannot walk more than 50 meters with one stick, crutch or brace;
8=Bilateral assistance: able to walk considerably longer than 100 meters (>120 meters) with two sticks, crutches or braces;
9=Bilateral assistance: a patient needs two sticks, crutches or braces to walk between 10 and 120 meters;
10=Essentially restricted to wheelchair, Unable to walk beyond approximately five meters even with aid;
11=Restricted to wheelchair, unable to take more than a few steps—may need aid in transfer—wheels self but cannot carry on in standard wheelchair a full day;
12=Essentially restricted to bed or chair or perambulated in wheelchair, but may be out of bed itself much of the day —retains many self-care functions—generally has effective use of arms;
13=Essentially restricted to bed much of day—has some effective use of arms retains some self care functions;
14=Confined to bed—can still communicate and eat; and
15=Totally helpless bed patient—unable to communicate effectively or eat/swallow.

Each of the preceding categories is associated with a numeric score by the system, and once a category is selected (e.g., in a user interface display) the associated numeric score can be used by the system in combination with functional system scores to generate a final assessment score. In one example, the preceding categories are assigned values from 0 (unrestricted)) to 15 (totally helpless) respectively.

According to some embodiments, scoring systems can include rules for combination of various assessment values. The scoring rules can be stored as a data object on various computer systems in a variety of formats (e.g., as a file, attribute, database, data record, etc.). According to some examples, the scoring rules can be configured to implement a variety of approved assessment methodologies discussed herein.

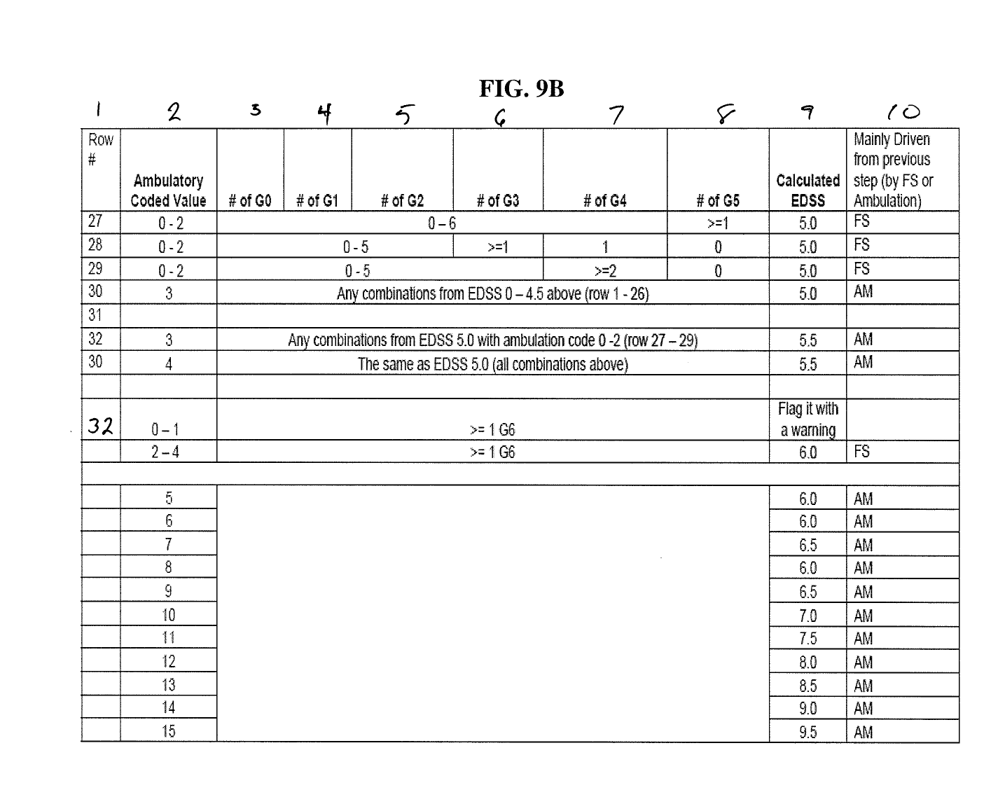

One implementation provides a series of rules for execution by the scoring system that combines FS scores with an ambulation score to generate a final assessment value. FIGS. 9A-B illustrate the calculation of a “Calculated EDSS” score according to one implementation of a set of scoring rules implemented by a scoring system. In FIGS. 9A-B, an ambulatory value (e.g., column 2) when combined with FS scores having the characteristics identified, for example, in columns 3-8 generates an assessment score (e.g., “Calculated EDSS”) in column 9. It is realized that progression of scoring can be attributed to either changes in the FS scores or the ambulation score. Calculated EDSS values under 6.0 are mostly driven by changes in FS scores and Calculated EDSS values 6.0 and over are mostly driven by Ambulation score. (see Column 10). Each column for FS scores identifies an number of values for each scoring criteria (e.g., # of G0—reflects the number of FS scores of 0, # of G1—reflects the number of FS scores of 1, # of G2—reflects the number of FS scores of 2, etc.). Once values for FS score include one or more values of 6 or greater (See. FIG. 9B), then ambulation score drives the resulting calculation of column 9. In one example, an ambulation score of 0-1 in combination with FS scores having at least on value of 6 or greater may generate a system warning (see row 32 of FIG. 9B). In this example, FS scores including a value of 6 or greater can be expected to include greater ambulation impairment or vice versa. Thus, in some examples, the system can be configured to request confirmation and/or highlight a potentially aberrant score.

### Population Consistency

According to another aspect, consistency can also be improved through selection of populations to study. In some embodiments, stable pre-treatment assessment scores can be required prior to qualifying a patient's participation in a study. According to some embodiments, difference between screening and baseline (Week 0) EDSS scores are obtained on candidate patients. In one example, differences between the screening and baseline score cannot be greater than 1 step (e.g., Calculated EDSS difference of 0.5 points). In some embodiments, a scoring system can be configured to record and analyze candidate patients to determine that the candidate meets the stability requirement. The system can analyze input values and flag candidates who exceed the stability boundary.

In some executions, the system can notify the study coordinator of any failures. The study coordinator can also be responsible for checking these values by comparing the total scores from screening and baseline and inform an EDSS evaluator of the results. In some implementations, the system can implement a processing requirement not to remind the EDSS evaluator of previous EDSS scores when completing a new examination (e.g., locking out access to prior results). In some implementations if the difference is greater than 1 step a second baseline EDSS score can be calculated prior to randomization. In such settings, at least 2 of the 3 pre-treatment EDSS scores should be within 1 step (0.5 points) of each other for the subject to be randomized or included. In some embodiments, the system can control whether a subject is approved for randomization based, e.g., on whether the pre-treatment EDSS scores are stable.

In further embodiments, population consistency can be improved by accounting for additional or different criteria. For example, the system can implement functions for excluding neurological abnormalities not due to MS. According to one embodiment, the system is configured to accept evaluator (e.g., doctor) input during execution of the initial EDSS to mark for exclusion any neurological abnormality not due to MS. For example, the system can be configured to provide user interface displays to enable designation of neurological abnormalities not attributable to MS. The system can be configured to automatically exclude those assessments from further testing at follow up visits, eliminating a source of error.

### MS Therapeutic Agents, Compositions and Administration

There are several medications presently used to modify the course of multiple sclerosis in patients. Such agents include, but are not limited to, Beta interferons (e.g., Avonex®, Rebif®, Betaseron®, Betaferon® etc.), glatiramer (Copaxone®), natalizumab (Tysabri®), fingolimod (Gilenya®), dimethylfumarate (Tecfidera®), teriflunomide (Aubagio®) and mitoxantrone (Novantrone®).

### IFNβ Agents (Beta Interferons)

One known therapy for MS includes treatment with interferon beta. Interferons (IFNs) are natural proteins produced by the cells of the immune systems of most animals in response to challenges by foreign agents such as viruses, bacteria, parasites and tumor cells. Interferons belong to the large class of glycoproteins known as cytokines. Interferon beta has 165 amino acids. Interferons alpha and beta are produced by many cell types, including T-cells and B-cells, macrophages, fibroblasts, endothelial cells, osteoblasts and others, and stimulate both macrophages and NK cells. Interferon gamma is involved in the regulation of immune and inflammatory responses. It is produced by activated T-cells and Th1 cells.

Several different types of interferon are now approved for use in humans. Interferon alpha (including forms interferon alpha-2a, interferon alpha-2b, and interferon alfacon-1) was approved by the United States Food and Drug Administration (FDA) as a treatment for Hepatitis C. There are two currently FDA-approved types of interferon beta. Interferon beta 1a (Avonex®) is identical to interferon beta found naturally in humans, and interferon beta 1b (Betaseron®) differs in certain ways from interferon beta 1a found naturally in humans, including that it contains a serine residue in place of a cysteine residue at position 17. Other uses of interferon beta have included treatment of AIDS, cutaneous T-cell lymphoma, Acute Hepatitis C (non-A, non-B), Kaposi's sarcoma, malignant melanoma, and metastatic renal cell carcinoma.

IFNβ agents can be administered to the subject by any method known in the art, including systemically (e.g., orally, parenterally, subcutaneously, intravenously, rectally, intramuscularly, intraperitoneally, intranasally, transdermally, or by inhalation or intracavitary installation). Typically, the IFNβ agents are administered subcutaneously, or intramuscularly.

IFNβ agents can be used to treat those subjects determined to be “responders” using the methods described herein. In one embodiment, the IFNβ agents are used as a monotherapy (i.e., as a single “disease modifying therapy”) although the treatment regimen can further comprise the use of “symptom management therapies” such as antidepressants, analgesics, anti-tremor agents, etc. In one embodiment, the IFNβ agent is an IFNβ-1A agent (e.g., Avonex®, Rebif®). In another embodiment, the INFβ agent is an INFβ-1B agent (e.g., Betaseron®, Betaferon®).

Avonex®, an Interferon β-1a, is indicated for the treatment of patients with relapsing forms of MS that are determined to be responders using the methods described herein to slow the accumulation of physical disability and decrease the frequency of clinical exacerbations. Avonex® (Interferon beta-1a) is a 166 amino acid glycoprotein with a predicted molecular weight of approximately 22,500 daltons. It is produced by recombinant DNA technology using genetically engineered Chinese Hamster Ovary cells into which the human interferon beta gene has been introduced. The amino acid sequence of Avonex® is identical to that of natural human interferon beta. The recommended dosage of Avonex® (Interferon beta-1a) is 30 mcg injected intramuscularly once a week. Avonex® is commercially available as a 30 mcg lyophilized powder vial or as a 30 mcg prefilled syringe.

Interferon beta Ia (Avonex®) is identical to interferon beta found naturally in humans (AVONEX®, i.e., Interferon beta Ia (SwissProt Accession No. P01574 and gi:50593016). The sequence of interferon beta is:

(SEQ ID NO: 1)
MTNKCLLQIALLLCFSTTALSMSYNLLGFLQRSSNFQCQKLLWQLNGRLE
YCLKDRMNFDIPEEIKQLQQFQKEDAALTIYEMLQNIFAIFRQDSSSTGW
NETIVENLLANVYHQINHLKTVLEEKLEKEDFTRGKLMSSLHLKRYYGRI
LHYLKAKEYSHCAWTIVRVEILRNFYFINRLTGYLRN.

Methods for making Avonex® are known in the art.

Treatment of responders identified using the methods described herein further contemplates that compositions (e.g., IFN beta 1 a molecules) having biological activity that is substantially similar to that of AVONEX® will permit successful treatment similar to treatment with AVONEX® when administered in a similar manner. Such other compositions include, e.g., other interferons and fragments, analogues, homologues, derivatives, and natural variants thereof with substantially similar biological activity. In one embodiment, the INFβ agent is modified to increase one or more pharmacokinetic properties. For example, the INFβ agent can be a modified form of interferon 1a to include a pegylated moiety. PEGylated forms of interferon beta 1a are described in, e.g., Baker, D. P. et al. (2006) Bioconjug Chem 17(1):179-88; Arduini, R M et al. (2004) Protein Expr Purif 34(2):229-42; Pepinsky, R B et al. (2001) J. Pharmacol. Exp. Ther. 297(3):1059-66; Baker, D. P. et al. (2010) J Interferon Cytokine Res 30(10):777-85 (all of which are incorporated herein by reference in their entirety, and describe a human interferon beta 1a modified at its N-terminal alpha amino acid to include a PEG moiety, e.g., a 20 kDa mPEG-O-2-methylpropionaldehyde moiety). Pegylated forms of IFN beta 1a can be administered by, e.g., injectable routes of administration (e.g., subcutaneously).

Rebif® is also an Interferon β-1a agent, while Betaseron® and Betaferon® are Interferon β-1b agents. Both Rebif® and Betaseron® are formulated for administration by subcutaneous injection.

Dosages of IFNβ agents to administer can be determined by one of skill in the art, and include clinically acceptable amounts to administer based on the specific interferon-beta agent used. For example, AVONEX® is typically administered at 30 microgram once a week via intramuscular injection. Other forms of interferon beta 1a, specifically REBIF®, are administered, for example, at 22 microgram three times a week or 44 micrograms once a week, via subcutaneous injection. Interferon beta-1A can be administered, e.g., intramuscularly, in an amount of between 10 and 50 μg. For example, AVONEX® can be administered every five to ten days, e.g., once a week, while Rebif® can be administered three times a week.

### Non-IFNβ Agents

In subjects determined to be non-responders using the methods described herein, a skilled physician can select a therapy that includes a non-IFNβ agent, e.g., glatiramer (Copaxone®), natalizumab (Tysabri®, Antegren®), mitoxantrone (Novantrone®), fingolimod (Gilenia®), dimethyl fumarate (Tecfidera®), a reparative agent; an anti-LINGO-1 antibody, an inhibitor of a dihydroorotate dehydrogenase (e.g., teriflunomide), among others.

Steroids, e.g., corticosteroid, and ACTH agents can be used to treat acute relapses in relapsing-remitting MS or secondary progressive MS. Such agents include, but are not limited to, Depo-Medrol®, Solu-Medrol®, Deltasone®, Delta-Cortef®, Medrol®, Decadron®, and Acthar®.

### Natalizumab (Tysabri®)

Natalizumab inhibits the migration of leukocytes from the blood to the central nervous system. Natalizumab binds to VLA-4 (also called α4β1) on the surface of activated T-cells and other mononuclear leukocytes. It can disrupt adhesion between the T-cell and endothelial cells, and thus prevent migration of mononuclear leukocytes across the endothelium and into the parenchyma. As a result, the levels of pro-inflammatory cytokines can also be reduced. Natalizumab can decrease the number of brain lesions and clinical relapses in patients with relapse remitting multiple sclerosis and relapsing secondary-progressive multiple sclerosis.

Natalizumab and related VLA-4 binding antibodies are described, e.g., in U.S. Pat. No. 5,840,299. Monoclonal antibodies 21.6 and HP1/2 are exemplary murine monoclonal antibodies that bind VLA-4. Natalizumab is a humanized version of murine monoclonal antibody 21.6 (see, e.g., U.S. Pat. No. 5,840,299). A humanized version of HP 1/2 has also been described (see, e.g., U.S. Pat. No. 6,602,503). Several additional VLA-4 binding monoclonal antibodies, such as HP2/1, HP2/4, L25 and P4C2, are described, e.g., in U.S. Pat. No. 6,602,503; Sanchez-Madrid et al, (1986) Eur. J. Immunol 16:1343-1349; Hemler et al, (1987) J Biol. Chem. 2:11478-11485; Issekutz et al. (1991) J Immunol 147: 109 (TA-2 mab); Pulido et al. (1991) J Biol. Chem. 266: 10241-10245; and U.S. Pat. No. 5,888,507).

### Dimethyl Fumarate (Tecfidera®)

Dimethyl fumarate, DMF, (Tecfidera®) is a fumaric acid ester. DMF is thought to decrease leukocyte passage through the blood brain barrier and exert neuroprotective effects by the activation of antioxidative pathways, specifically through activation of the Nrf-2 pathway (Lee et al. (2008) Int MS Journal 15: 12-18). Research also suggests that DMF has the potential to reduce the activity and impact of inflammatory cells on the CNS and induce direct cytoprotective responses in CNS cells. These effects may enhance the CNS cells' ability to mitigate the toxic inflammatory and oxidative stress that plays a role in MS pathophysiology.

### Glatiramer Acetate (Copaxone®)

Glatiramer acetate (Copaxone®) consists of the acetate salts of synthetic polypeptides, specifically the four naturally occurring amino acids: L-glutamic acid, L-alanine, L-tyrosine, and L-lysine (Bornstein et al. (1987) N Engl J Med. 317: 408-414). Copaxone® exhibits structural similarity to myelin basic protein and is thought to function as an immune modulator by shifting the T helper cell type 1 response towards a T helper cell type 2 response (Duda et al. (2000) J Clin Invest 105: 967-976; Nicholas et al. (2011) Drug Design, Development, and Therapy 5: 255-274).

### Anti-LINGO-1 Antibody

LINGO-1 is a negative regulator of myelination and neuroaxonal growth. Antagonizing LINGO-1 has the potential to enhance remyelination and neuroaxonal protection in the CNS. This remyelination and neuroaxonal protection may be provided via blockade of signaling by myelin debris on the NgR1 receptor complex in the CNS caused by the inhibition of LINGO-1 in axons and oligodendrocytes. This in turn may promote remyelination via differentiation of oligodendrocyte precursor cells (OPCs) normally present in the brain of MS patients. Anti-LINGO-1 antibodies are described, for example, in U.S. Pat. No. 8,058,406, entitled “Composition comprising antibodies to LINGO or fragments thereof.”

### Symptom Management

Treatment of a subject with a disease modifying IFNβ agent or non-IFNβ agent can be combined with one or more of the following therapies often used in symptom management of subjects having MS: Imuran® (azathioprine), Cytoxan® (cyclophosphamide), Neosar® (cyclophosphamide), Sandimmune® (cyclosporine), methotrexate, Leustatin® (cladribine), Tegretol® (carbamazepine), Epitol® (carbamazepine), Atretol® (carbamazepine), Carbatrol® (carbamazepine), Neurontin® (gabapentin), Topamax® (topiramate), Zonegran® (zonisamide), Dilantin® (phenytoin), Norpramin® (desipramine), Elavil® (amitriptyline), Tofranil® (imipramine), Imavate® (imipramine), Janimine® (imipramine), Sinequan® (doxepine), Adapin® (doxepine), Triadapin® (doxepine), Zonalon® (doxepine), Vivactil® (protriptyline), Marinol® (synthetic cannabinoids), Trental® (pentoxifylline), Neurofen® (ibuprofen), aspirin, acetaminophen, Atarax® (hydroxyzine), Prozac® (fluoxetine), Zoloft® (sertraline), Lustral® (sertraline), Effexor XR® (venlafaxine), Celexa® (citalopram), Paxil®, Seroxat®, Desyrel® (trazodone), Trialodine® (trazodone), Pamelor® (nortriptyline), Aventyl® (imipramine), Prothiaden® (dothiepin), Gamanil® (lofepramine), Parnate® (tranylcypromine), Manerix® (moclobemide), Aurorix® (moclobemide), Wellbutrin SR® (bupropion), Amfebutamone® (bupropion), Serzone® (nefazodone), Remeron® (mirtazapine), Ambien® (zolpidem), Xanax® (alprazolam), Restoril® (temazepam), Valium® (diazepam), BuSpar® (buspirone), Symmetrel® (amantadine), Cylert® (pemoline), Provigil® (modafinil), Ditropan XL® (oxybutynin), DDAVP® (desmopressin, vasopressin), Detrol® (tolterodine), Urecholine® (bethane), Dibenzyline® (phenoxybenzamine), Hytrin® (terazosin), Pro-Banthine® (propantheline), Urispas® (hyoscyamine), Cystopas® (hyoscyamine), Lioresal® (baclofen), Hiprex® (methenamine), Mandelamine® (metheneamine), Macrodantin® (nitrofurantoin), Pyridium® (phenazopyridine), Cipro® (ciprofloxacin), Dulcolax® (bisacodyl), Bisacolax® (bisacodyl), Sani-Supp® (glycerin), Metamucil® (psyllium hydrophilic mucilloid), Fleet Enema® (sodium phosphate), Colace® (docusate), Therevac Plus®, Klonopin® (clonazepam), Rivotril® (clonazepam), Dantrium® (dantrolen sodium), Catapres® (clonidine), Botox® (botulinum toxin), Neurobloc® (botulinum toxin), Zanaflex® (tizanidine), Sirdalud® (tizanidine), Mysoline® (primidone), Diamox® (acetozolamide), Sinemet® (levodopa, carbidopa), Laniazid® (isoniazid), Nydrazid® (isoniazid), Antivert® (meclizine), Bonamine® (meclizine), Dramamine® (dimenhydrinate), Compazine® (prochlorperazine), Transderm® (scopolamine), Benadryl® (diphenhydramine), Antegren® (natalizumab), Campath-1H® (alemtuzumab), Fampridine® (4-aminopyridine), Gammagard® (IV immunoglobulin), Gammar-IV® (IV immunoglobulin), Gamimune N® (IV immunoglobulin), Iveegam® (IV immunoglobulin), Panglobulin® (IV immunoglobulin), Sandoglobulin® (IV immunoglobulin), Venoblogulin® (IV immunoglobulin), pregabalin, ziconotide, and AnergiX-MS®.

In other embodiments, the method further includes the use of one or more therapies for management of cognitive and/or memory impairment. Examples of such therapies include, but are not limited to, agents that increase the level of neurotransmitters in the brain, NMDA receptor agents, and CNS stimulants (e.g., dextro or levo amphetamines).

A subject identified as a progressor can be treated with one or more agents described herein to manage symptoms.

### Therapeutic Methods

“Treat,” “treatment,” and other forms of this word refer to the administration of a therapy (e.g., an MS therapy), alone or in combination with one or more symptom management agents, to a subject, e.g., an MS patient, to impede progression of multiple sclerosis, to induce remission, to restore function, to extend the expected survival time of the subject and or reduce the need for medical interventions (e.g., hospitalizations). In those subjects, treatment can include, but is not limited to, inhibiting or reducing one or more symptoms such as numbness, tingling, muscle weakness; reducing relapse rate, reducing size or number of sclerotic lesions; inhibiting or retarding the development of new lesions; prolonging survival, or prolonging progression-free survival, and/or enhanced quality of life and improving established disability.

As used herein, unless otherwise specified, the terms “prevent,” “preventing” and “prevention” contemplate an action that occurs before a subject begins to suffer from the a multiple sclerosis relapse or progression and/or which inhibits or reduces the severity of the disease.

As used herein, and unless otherwise specified, the terms “manage,” “managing” and “management” encompass preventing the progression of MS symptoms in a patient who has already suffered from the disease, and/or lengthening the time that a patient who has suffered from MS remains in remission. The terms encompass modulating the threshold, development and/or duration of MS, or changing the way that a patient responds to the disease.

As used herein, and unless otherwise specified, a “therapeutically effective amount” of a compound is an amount sufficient to provide a therapeutic benefit in the treatment or management of multiple sclerosis, or to delay or minimize one or more symptoms associated with MS. A therapeutically effective amount of a compound means an amount of therapeutic agent, alone or in combination with other therapeutic agents, which provides a therapeutic benefit in the treatment or management of MS. The term “therapeutically effective amount” can encompass an amount that improves overall therapy, reduces or avoids symptoms or causes of the disease, or enhances the therapeutic efficacy of another therapeutic agent.

As used herein, and unless otherwise specified, a “prophylactically effective amount” of a compound is an amount sufficient to prevent relapse of MS, or one or more symptoms associated with the disease, or prevent its recurrence. A prophylactically effective amount of a compound means an amount of the compound, alone or in combination with other therapeutic agents, which provides a prophylactic benefit in the prevention of MS relapse. The term “prophylactically effective amount” can encompass an amount that improves overall prophylaxis or enhances the prophylactic efficacy of another prophylactic agent.

As used herein, the term “patient” or “subject” refers to a mammal, typically a human (i.e., a male or female of any age group, e.g., a pediatric patient (e.g., infant, child, adolescent) or adult patient (e.g., young adult, middle-aged adult or senior adult) or other mammal, such as a primate (e.g., cynomolgus monkey, rhesus monkey); commercially relevant mammals such as cattle, pigs, horses, sheep, goats, cats, and/or dogs; and/or birds, including commercially relevant birds such as chickens, ducks, geese, and/or turkeys, that will be or has been the object of treatment, observation, and/or experiment. When the term is used in conjunction with administration of a compound or drug, then the patient has been the object of treatment, observation, and/or administration of the compound or drug.

The methods described herein permit one of skill in the art to identify a monotherapy that an MS patient is most likely to respond to, thus eliminating the need for administration of multiple therapies to the patient to ensure that a therapeutic effect is observed. However, in one embodiment, combination treatment of an individual with MS is contemplated.

### Combination Therapy

It will be appreciated that any MS therapy, e.g., Avonex®, as described above and herein, can be administered in combination with one or more additional therapies to treat and/or reduce the symptoms of MS described herein, particularly to treat patients with moderate to severe disability (e.g., EDSS score of 5.5 or higher). The pharmaceutical compositions can be administered concurrently with, prior to, or subsequent to, one or more other additional therapies or therapeutic agents. In general, each agent will be administered at a dose and/or on a time schedule determined for that agent. In will further be appreciated that the additional therapeutic agent utilized in this combination can be administered together in a single composition or administered separately in different compositions. The particular combination to employ in a regimen will take into account compatibility of the pharmaceutical composition with the additional therapeutically active agent and/or the desired therapeutic effect to be achieved. In general, it is expected that additional therapeutic agents utilized in combination be utilized at levels that do not exceed the levels at which they are utilized individually. In some embodiments, the levels utilized in combination will be lower than those utilized individually.

Treatment of a subject with a disease modifying IFNβ agent or non-IFNβ agent can be combined with one or more other disease modifying IFNβ agent or non-IFNβ agents. Treatment of a subject with a disease modifying IFNβ agent, e.g., Avonex®, Rebif®, Betaseron®, Betaferon® can be combined with an alternative therapy, anti-LINGO-1 antibody; and/or anti-CD20 antibody e.g., rituximab or ocrelizumab.

The methods provided herein are useful for identifying subjects as progressors or non-progressors. In some embodiments, the disease progression value as described herein, is acquired for a subject with a progressive form of MS at two or more time points (e.g., at baseline and 6 months; or at baseline and 6 months after the initiation of therapy; or at the time there is a change in therapy and 6 months post the change in therapy). In some embodiments, a subject is classified as progressor or a non-progressor based on a change in the disease progression value during longitudinal follow up with recurrent periodic assessments.

The methods provided herein are also useful for identifying subjects that are more likely to respond to, or are in need of, an alternative therapy, e.g., Tysabri®, Tecfidera®, Gilenya®. In some embodiments, a disease progression value is measured prior to the initiation of an alternative therapy, and based solely on the disease progression value or based on the disease progression value in combination with other factors (e.g., presence or absence or degree of cognitive impairment associated with MS); an alternative therapy is recommended or administered. The methods provided herein are also particularly useful for identifying subjects that are not in need of an alternative therapy, e.g., Tysabri®, Tecfidera®. In some embodiments, a disease progression value is measured prior to the initiation of a therapy, and based solely on the disease progression value or based on the disease progression value in combination with other factors (e.g., presence/absence or degree of cognitive symptoms associated with MS); an alternative therapy, e.g., Copaxone®, IFN-β agents, e.g., Avonex®, Rebif®, Betaseron®, and/or Betaferon®, is recommended or administered.

The methods provided herein are also useful for identifying subjects that are more likely to respond to or are in need of an alternative therapy, e.g., anti-LINGO-1 antibody; anti-CD20 antibody e.g., ocrelizumab. In some embodiments, a disease progression value is measured, and based solely on the disease progression value or based on the disease progression value in combination with other factors (e.g., presence or absence or degree of cognitive symptoms associated with MS); an alternative therapy is recommended or administered. In a preferred embodiment, a subject being treated with an IFN-β agents, e.g., Avonex®, is identified as a subject more likely to respond to or in need of an alternative therapy, and an anti-LINGO-1 antibody; anti-CD20 antibody e.g., ocrelizumab is administered in combination with the IFN-β agents, e.g., Avonex®.

The methods provided herein are also useful for identifying subjects that are not more likely to respond to or are not in need of an alternative therapy, e.g., anti-LINGO-1 antibody; anti-CD20 antibody e.g., ocrelizumab. In some embodiments, a disease progression value is measured, and based solely on the disease progression value or based on the disease progression value in combination with other factors (e.g., presence or absence or degree of cognitive symptoms associated with MS); an alternative therapy is not recommended or withheld.

The methods described herein can also be used to monitor a response to a therapy. Such methods are useful for detection of tolerance to a therapy, ineffectiveness of a therapy, or a positive response to a therapy. In some embodiments, a disease progression value is measured at least 3 months, at least 4 months, at least 5 months, at least 6 months, at least 7 months, at least 8 months, or at least 1 year after initiation of a therapy. In some embodiments, it is preferred that a disease progression value is measured less than 7 months after initiation of a therapy to permit the skilled practitioner to switch the subject to a different therapeutic strategy before further accumulation of disability or loss of function. In some embodiments, it is preferred that a disease progression value is measured more than 3 months after initiation of therapy. In some embodiments, it is preferred that a disease progression value is measured more than 3 months but less than 7 months after initiation of therapy. Thus, in some embodiments it is preferred that a disease progression value is measured within 1-8 months, 1-7 months, 1-6 months, 1-5 months, 1-4 months, 1-3 months of the initiation of a therapy.

In some embodiments, the disease progression value is compared to a reference value or cut-off value. For example, a cut off value can be determined that represents a progressor status; any value falling above the cut-off value are classified as a progressor. In another example, a cut-off value can be determined that represents a particular therapy should be administered, e.g., an alternative therapy, e.g., anti-LINGO-1 antibody; and/or anti-CD20 antibody e.g., ocrelizumab. In another example, a cut-off value can be determined that represents a particular therapy should be administered, e.g., an alternative therapy, e.g., Tysabri®, Tecfidera®. In another example, a cut-off value can be determined that represents a non-responder status; any values falling above the cut-off value are likely to be a non-responder to a current therapy.

In some embodiments, a change in the disease progression value is determined. In one embodiment, the change in the disease progression value is determined by comparing the disease progression value acquired for a subject with MS at two or more timepoints (e.g., at baseline and 6 months after initiation of a therapy; 6 and 12 months after initiation of a therapy; at the time of a change in a therapy and 6 months post the change in a therapy; or at the time of a change in a therapy and 6 months and 12 months post the change in a therapy).

The present invention also pertains to the field of predictive medicine in which diagnostic assays, pharmacogenomics, and monitoring clinical trials are used for predictive purposes to thereby treat an individual prophylactically. Accordingly, one aspect of the present invention relates to methods for determining a disease progression value, in order to determine whether an individual having multiple sclerosis or at risk of developing multiple sclerosis should be classified as a progressor. Accordingly, one aspect of the present invention relates to assays for determining a disease progression value, in order to determine whether an individual having multiple sclerosis or at risk of developing multiple sclerosis should be administered an alternative therapy, e.g., anti-LINGO antibody; and/or anti-CD20 antibody e.g., ocrelizumab. Accordingly, one aspect of the present invention relates to assays for determining a disease progression value, in order to determine whether an individual having multiple sclerosis or at risk of developing multiple sclerosis should be administered a first therapy, e.g., Copaxone®, IFN-β agents, e.g., Avonex®, Rebif®, Betaseron®, and/or Betaferon®, or an alternative therapy, e.g., Tysabri®, and Tecfidera®.

In one aspect, the invention is drawn to a method for determining whether a subject is in need of a MS therapy. In another aspect, the method is drawn to selecting an MS therapy. In another aspect, the invention is drawn to a method of administering the MS therapy. In another aspect the, the invention is drawn to a method of altering dosing of the MS therapy. In another aspect, the invention is drawn to a method of altering a schedule or a time course of the MS therapy. In still another aspect, the invention is drawn to a method of administering an alternative MS therapy.

In certain embodiments, the method comprises acquiring a disease progression value from a subject as described herein, and determining whether the subject is in need of a MS therapy. In certain embodiments, the method comprises acquiring a disease progression value from a subject as described herein and selecting; altering composition of; altering dosage of; altering dosing schedule of; an MS therapy.

In some embodiments, the methods involve evaluation of a subject e.g., a patient, a patient group or a patient population, e.g., a patient who has been diagnosed with or is suspected of having multiple sclerosis, e.g., presents with symptoms of multiple sclerosis, to acquire a disease progression value as described herein.

In some embodiments, the results of the acquisition of the disease progression value and the interpretation thereof, are predictive that a patient has a progressive form of MS, should be classified as a progressor, or identified as a progressor. In some embodiments, the results of the acquisition of the disease progression value and the interpretation thereof, are predictive of the patient's need for or response to treatment with an alternative therapy, e.g., anti-LINGO-1 antibody; anti-CD20 antibody e.g., ocrelizumab. In some embodiments, the results of the acquisition of the disease progression value and the interpretation thereof, are predictive of the patient's need for or response to treatment with a first therapy, e.g., Avonex®, Rebif®, Betaseron®, Betaferon®, or an alternative therapy, e.g., Tysabri®, Tecfidera®, Gilenya®. According to the present invention, a disease progression value described herein, can be indicative that treatment with an alternative therapy, e.g., Tysabri®, Tecfidera®, or a combination therapy, e.g., anti LINGO antibody, should be recommended or administered.

In yet another embodiment, the disease progression value is assessed at pre-determined intervals, e.g., a first point in time and at least at a subsequent point in time. In one embodiment, a time course is measured by determining the time between significant events in the course of a patient's disease, wherein the measurement is predictive of whether a patient has a long time course. In another embodiment, the significant event is the progression from primary diagnosis to death. In another embodiment, the significant event is the progression from primary diagnosis to worsening disease. In another embodiment, the significant event is the progression from primary diagnosis to relapse. In another embodiment, the significant event is the progression from secondary MS to death. In another embodiment, the significant event is the progression from remission to relapse. In another embodiment, the significant event is the progression from relapse to death. In certain embodiments, the time course is measured with respect to one or more of overall survival rate, time to progression and/or using the EDSS or other assessment criteria.

The methods described herein can be used in any subject having MS, including but not limited to, a subject having a progressive form of MS including sub-types primary progressive MS (PPMS), and secondary progressive MS (SPMS); or at risk of having a progressive form of MS.

### Systems and Computer Environment

In another aspect, the invention features a system for evaluating a subject (e.g., a patient, a patient group or a patient population). The system includes at least one processor operatively connected to a memory, the at least one processor when executing is configured to determine or calculate a disease progression value associated with the subject, wherein the processor is further configured to calculate the disease progression value responsive to establishing an assessment of upper extremity function (e.g., 9 Hole Peg Test (9HP), alone or in combination with an assessment of neurological and ambulatory function (e.g., EDSS), and/or an assessment of lower extremity function or short distance ambulatory function (e.g., Timed Walk of 25 Feet (T25FW)), for the subject; and evaluate the subject, based on at least one value of the disease progression value established, e.g., prior to, during, or after the conclusion of, an MS therapy, or established responsive to administration of an MS therapy.

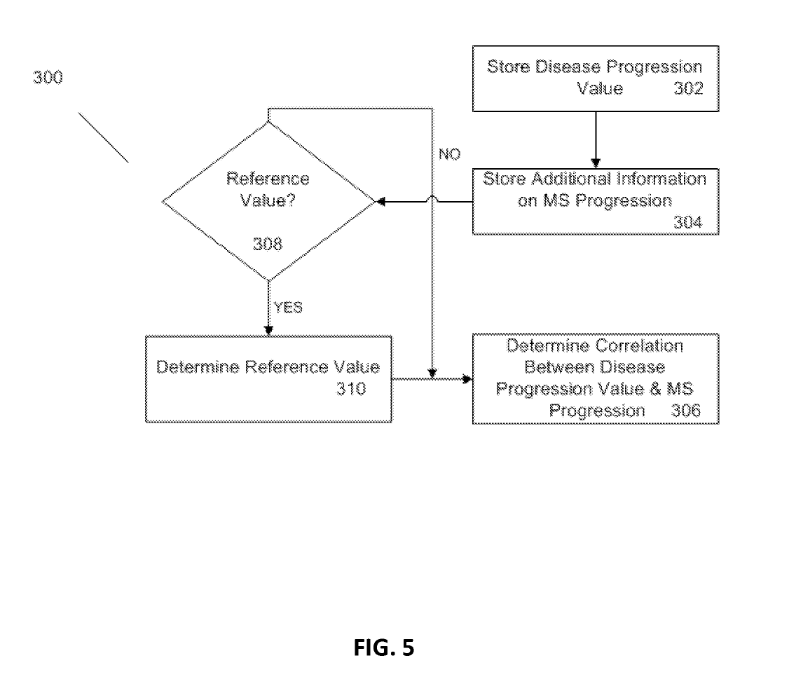

According to some embodiments, users (e.g., physicians, researchers, clinicians, patients, and other medical personnel) can interact with computer systems especially configured to monitor, manage, diagnose, prognose, and/or facilitate treatment of subjects having MS or subjects at risk for developing MS. For example, FIG. 5, illustrates an example process 300 that can be executed on a computer system for defining correlations between a disease progression value and progression of MS or MS symptoms in a subject. Process 300 begins at 302 with storing a disease progression value. Step 302 can be executed repeatedly over time to establish a history for one or more subjects. The one or more subjects can include healthy patients (e.g., patients showing no MS symptoms or patients not expected to develop MS) as well as patients who may develop MS, and patients diagnosed with MS. At 304, additional information associated with MS progression for a respective subject, including, for example, a health condition of the respective subject, can also be stored at 304 for any execution of 302.

In some embodiments, the values obtained in 302 can be used to define a reference value 308 YES. The reference value can be used to define a baseline level for function. At 310, a reference value can be determined and optionally stored for later use. In some embodiments, comparisons can be made between the reference value and disease progression values to determine a progression of MS, a likelihood of developing MS, efficacy of treatment for MS, to identify a need to change MS treatment, among other options. If a reference value is not presently being generated 308 NO or a reference value has been determined 310, process 300 continues at 306, where any correlation between the stored disease progression values and MS progression can be determined. For example, disease progression values for a first subject can be evaluated against subjects having a same or similar MS diagnosis. The progression of the first subject's MS can be used to predict the progression of MS in other subjects. The evaluation can also be used to identify a need for different or more aggressive treatment, for example, based on a prediction of worsening symptoms or outcome.

Further, in some embodiments reference values determined at 310 can be included in the evaluation, and deviations from the reference values can be used to evaluate progression of a subject's MS. For example, reference values can be taken and/or determined over time, e.g., at a first and subsequent time point. Reference values determined over time can reflect an expected change in function based, for example, on progression of MS in a reference patient or an average progression determined from a group of patients. In one embodiments, deviations from the expected change (e.g., a higher disease progression value than a reference score indicates improvement in the progression of the subject's MS even, for example, where the subject's function decreases over time (which can be reflected in analysis of the disease progression values alone), and a disease progression value lower than the time based reference indicates a worsening in the progression of the subject's MS) can be used to confirm an treatment in progress, identify need for a change in treatment, identify a need for a change in a time schedule of a treatment, etc. For example, the reference values determined over time can be used to evaluate subject over the course of a treatment, over the progression of MS for the subject, etc.

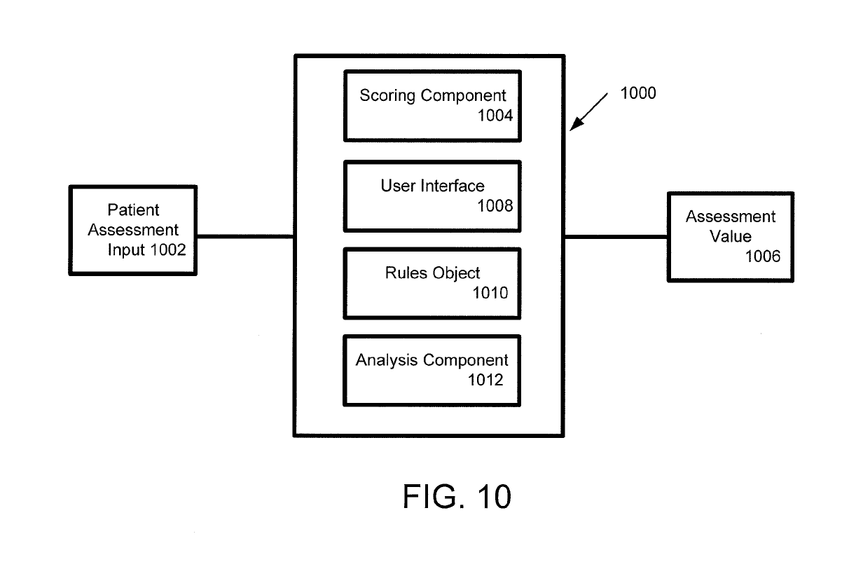

FIG. 10 illustrates an example system 1000 for generating assessment scores for a subject, e.g., an MS patient. The subject's assessment data can be entered at 1002. For example, FS scores and ambulation categories can be entered according to EDSS methodologies by an evaluator. The scoring system 1000 can include a scoring component 1004 configured to combine scoring values from FS scores, and an ambulation score associated with input categories to generate a calculated EDSS score (e.g., assessment value 1006).

According to some embodiments, the system 1000 can include a user interface 1008 configured to accept data input from evaluators and/or selection of ambulation categories from the evaluators. In further embodiments, system 1000 can include a rules object 1010 in which a set of rules is defined. In one example, the scoring component is configured to capture input data entered through user interface 1008, retrieve and execute scoring rules from the rules object 1010 to generate the final assessment value 1006.

The scoring component 1004 and/or the user interface 1008 can also be configured to analyze input data to determine validity of the input data. Data can also be analyzed for deviation from expected values. The system 1000 and/or user interface 1008 can notify evaluators of any issues with input values. In further embodiments, the system can include an analysis component 1012 configured to identify issues with input data (e.g., identify statistical outlier values, identify values exceeding a deviation, identify errors in calculation, etc.). In some embodiments, scoring system 1000 can also include management and/or administration components configured to manage scoring rules executed by the system. In some examples, new scoring rules can be added, old scoring rules can be made inactive or deleted, and/or existing scoring rules can be modified through an administration component.

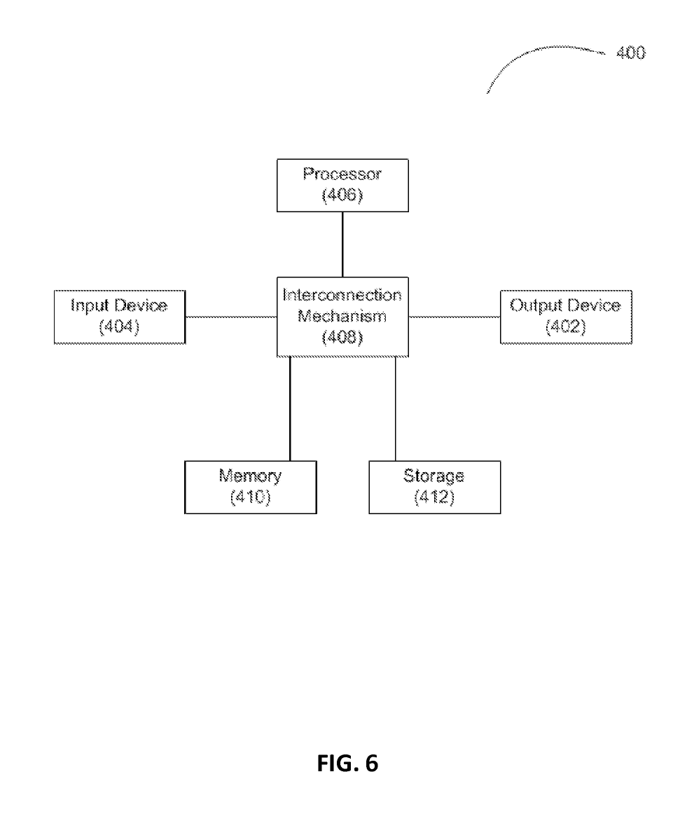

Various embodiments of a scoring system (e.g., 1000) can be configured to evaluate existing assessment scores. Existing scores, including for example, those not calculated by the system, can be compared to respective calculated values to insure the existing scores are correct, consistent with scoring rules, etc. System 1000 can be implemented on various computer system (e.g., as discussed below with respect to FIGS. 6-8).

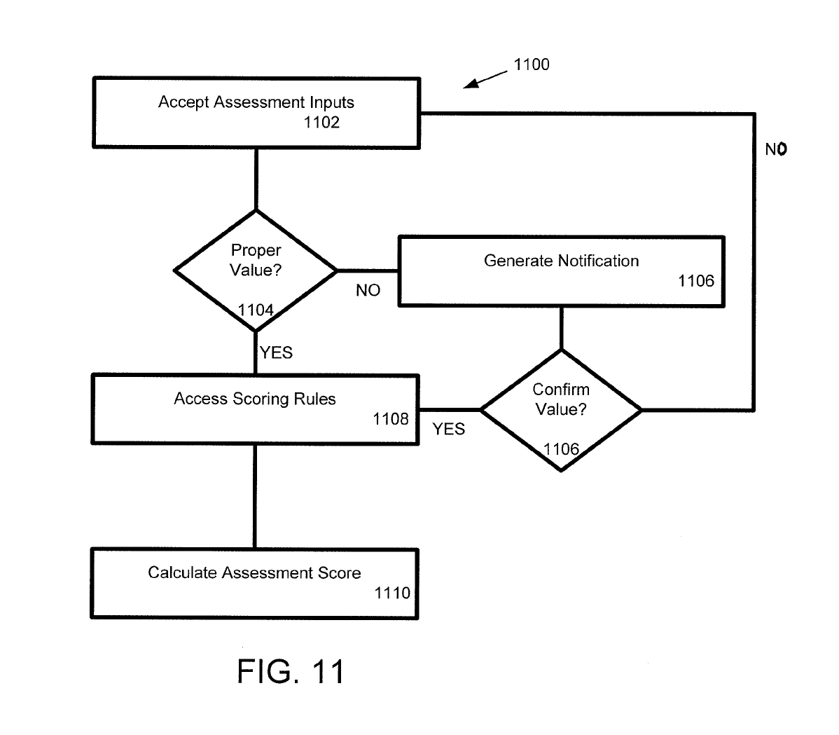

According to various embodiments, system 1000 can execute a variety of processes and/or functions discussed herein to generate assessment values. FIG. 11 illustrates one example process 1100 for generating an assessment value. The process 1100 begins at 1102 with accepting assessment inputs. The inputs can be evaluated at 1104 to determine if the values are proper (e.g., exceed bounds, statistical outlier, etc). If values are not proper 1104 (NO) then a notification can be generated at 1006. At 1008, if the user confirmed the value 1108 YES, the process proceeds to 1110. Additionally, the assessment input at 1102 is proper 1104 (YES), process 1100 also reaches 1110. At 1110, scoring rules are accessed and at 1112 an assessment score is calculated according to the scoring rules. Returning to 1108, if a value is not confirmed 1008 NO, process 1100 can proceed with re-entry of inputs at 1102.

Various embodiments according to the present invention may be implemented on one or more specially programmed computer systems. These computer systems may be, for example, general-purpose computers such as those based on Intel PENTIUM-type processor, Motorola PowerPC, AMD Athlon or Turion, Sun UltraSPARC, Hewlett-Packard PA-RISC processors, or any other type of processor, including multi-core processors. It should be appreciated that one or more of any type computer system may be used to perform a method of evaluating a subject having multiple sclerosis (MS), or at risk of developing MS according to various embodiments of the invention. Further, the system may be located on a single computer or may be distributed among a plurality of computers attached by a communications network.

A general-purpose computer system according to one embodiment of the invention is specially configured to perform any of the described functions, including but not limited to, acquiring a disease progression value from a subject, said disease progression value including a measure of one, two, three, or more of:

(i) an assessment of neurological and/or ambulatory function (e.g., EDSS),

(ii) an assessment of lower extremity ambulatory function (e.g., T25FW), or

(iii) an assessment of upper extremity ambulatory function (e.g., 9HP test), identifying a subject as being in need of an MS therapy, administering a MS therapy, monitoring administration of an MS therapy, altering a dosing of the MS therapy, altering a schedule or a time course of a MS therapy, administering an alternative MS therapy, etc. Additional functions include, for example, comparing a disease progression value from the subject to a reference value, performing one or more of: identifying the subject as being in need of an MS therapy, administering an MS therapy, altering a dosing of an MS therapy, altering a schedule or a time course of an MS therapy, or selecting an alternative MS therapy responsive to a determination of the disease progression value.

It should be appreciated that the system may perform other functions, including identifying an increase in the disease progression value relative to the reference value as indicative of decreased function in the subject in response to MS therapy, determining a disease progression value that differs according to the severity of MS, wherein an increase in the disease progression value relative to the reference value, is indicative of decreased function in the subject, identifying trends in the disease progression value based at least in part on the type of MS, for example, in a patient having relapse remitting multiple sclerosis (RRMS) identifying patients having a lower disease progression value compared to a patient with secondary progressive multiple sclerosis (SPMS), wherein a decrease in the value of the disease progression value, relative to a reference value, is indicative of increased function in a subject, evaluating one, two, three, or more of:

(i) an assessment of neurological and/or ambulatory function (e.g., EDSS),

(ii) an assessment of lower extremity ambulatory function (e.g., T25FW test), or

(iii) an assessment of upper extremity function (e.g., 9HP test). The functions, operations, and/or algorithms described herein can also be encoded as software executing on hardware that together define a processing component, that can further define one or more portions of a specially configured general purpose computer, that reside on an individual specially configured general purpose computer, and/or reside on multiple specially configured general purpose computers.

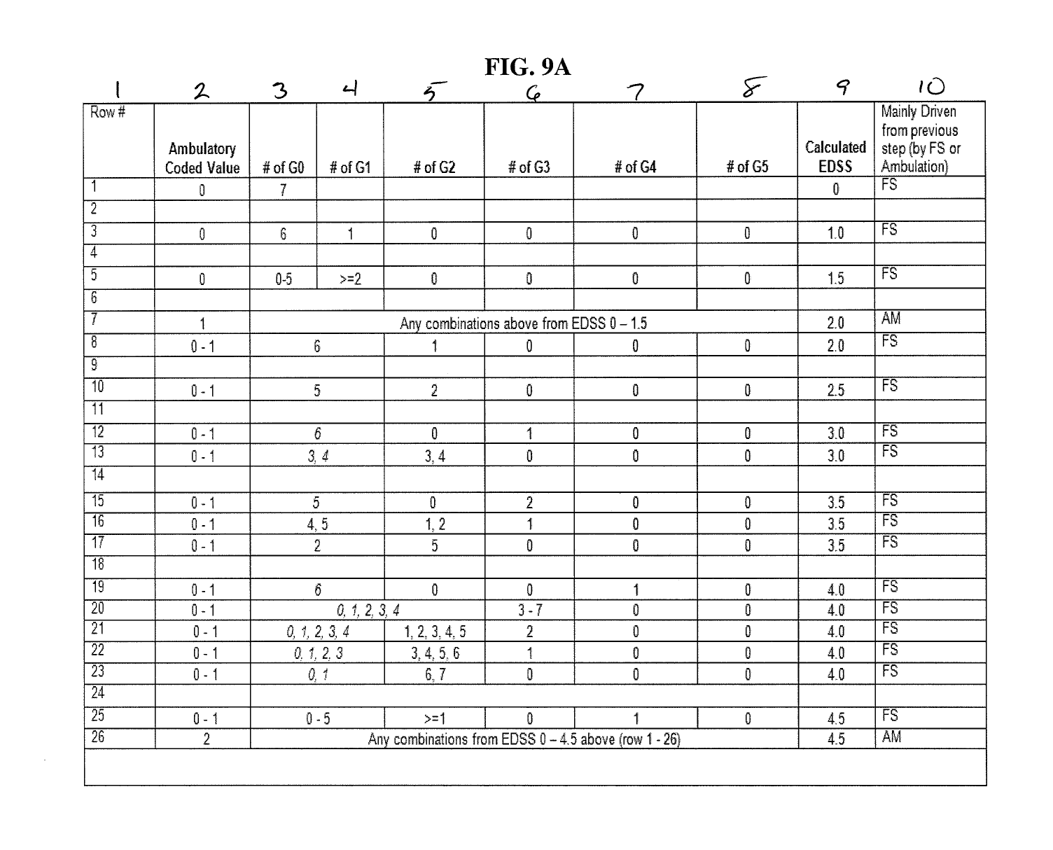

FIG. 6 shows an example block diagram of a general-purpose computer system 400 which can be especially configured to practice various aspects of the invention discussed herein. For example, various aspects of the invention can be implemented as specialized software executing in one or more computer systems including general-purpose computer systems 604, 606, and 608 communicating over network 602 shown in FIG. 8. Computer system 400 may include a processor 406 connected to one or more memory devices 410, such as a disk drive, memory, or other device for storing data. Memory 410 is typically used for storing programs and data during operation of the computer system 400. Components of computer system 400 can be coupled by an interconnection mechanism 408, which may include one or more busses (e.g., between components that are integrated within a same machine) and/or a network (e.g., between components that reside on separate discrete machines). The interconnection mechanism 408 enables communications (e.g., data, instructions) to be exchanged between system components of system 400.

Computer system 400 may also include one or more input/output (I/O) devices 402-204, for example, a keyboard, mouse, trackball, microphone, touch screen, a printing device, display screen, speaker, etc. Storage 412, typically includes a computer readable and writeable nonvolatile recording medium in which instructions are stored that define a program to be executed by the processor or information stored on or in the medium to be processed by the program.

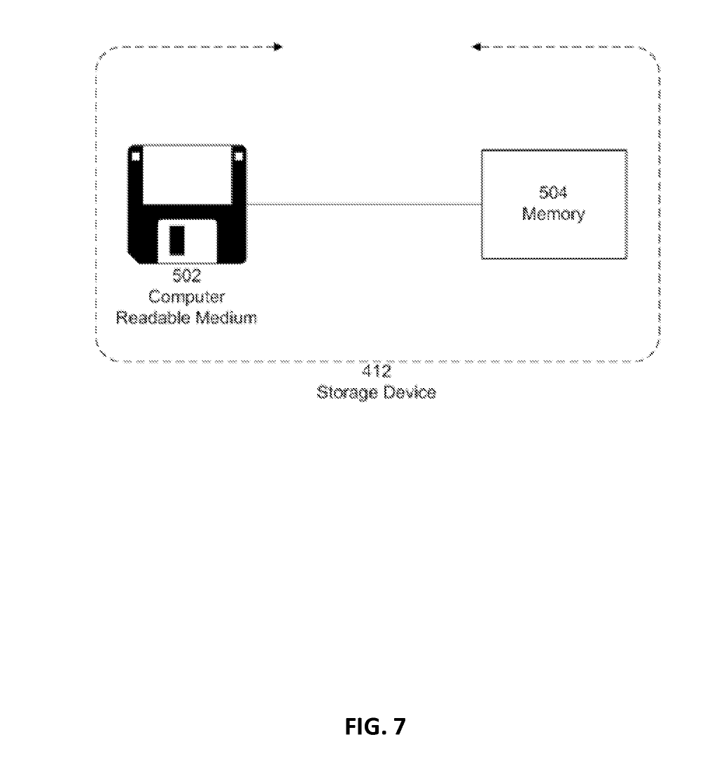

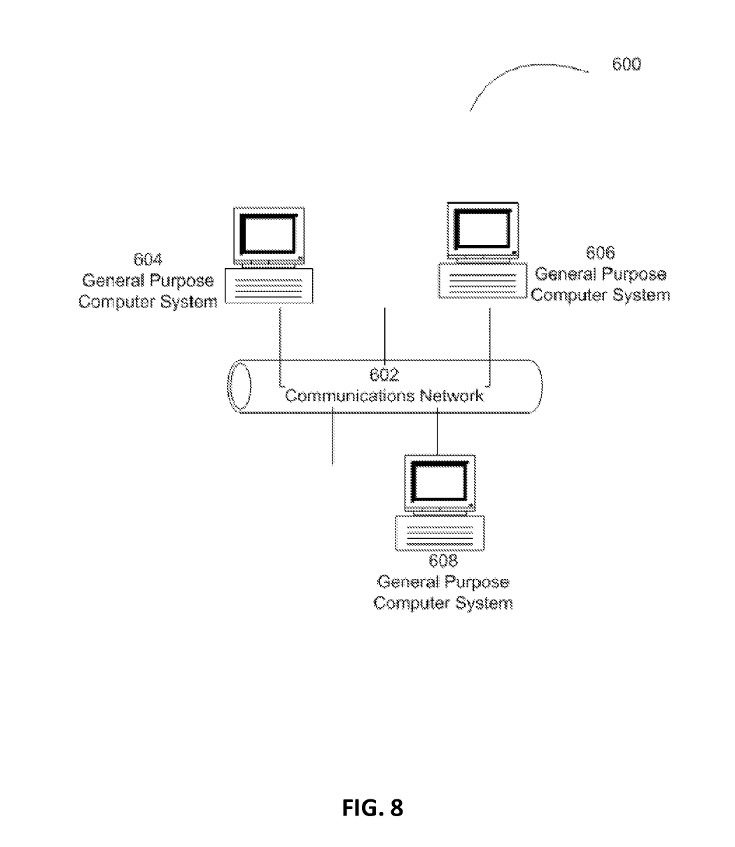

The medium may, for example, be a disk 502 or flash memory as shown in FIG. 7. Typically, in operation, the processor causes data to be read from the nonvolatile recording medium into another memory 504 that allows for faster access to the information by the processor than does the medium. This memory is typically a volatile, random access memory such as a dynamic random access memory (DRAM) or static memory (SRAM). In one example, the computer-readable medium is a non-transient storage medium.

Referring again to FIG. 6, the memory can be located in storage 412 as shown, or in memory system 410. The processor 406 generally manipulates the data within the memory 410, and then copies the data to the medium associated with storage 412 after processing is completed. A variety of mechanisms are known for managing data movement between the medium and integrated circuit memory element and the invention is not limited thereto. The invention is not limited to a particular memory system or storage system.

The computer system may include specially-programmed, special-purpose hardware, for example, an application-specific integrated circuit (ASIC). Aspects of the invention can be implemented in software executed on hardware, hardware or firmware, or any combination thereof. Although computer system 400 is shown by way of example as one type of computer system upon which various aspects of the invention can be practiced, it should be appreciated that aspects of the invention are not limited to being implemented on the computer system as shown in FIG. 6. Various aspects of the invention can be practiced on one or more computers having a different architectures or components than that shown in FIG. 6.

It should also be appreciated that the invention is not limited to executing on any particular system or group of systems. Also, it should be appreciated that the invention is not limited to any particular distributed architecture, network, or communication protocol.

Various embodiments of the invention can be programmed using an object-oriented programming language, such as Java, C++, Ada, or C# (C-Sharp). Other object-oriented programming languages may also be used. Alternatively, functional, scripting, and/or logical programming languages can be used. Various aspects of the invention can be implemented in a non-programmed environment (e.g., documents created in HTML, XML or other format that, when viewed in a window of a browser program, render aspects of a graphical-user interface (GUI) or perform other functions). The system libraries of the programming languages are incorporated herein by reference. Various aspects of the invention can be implemented as programmed or non-programmed elements, or any combination thereof.

Various aspects of this invention can be implemented by one or more systems similar to system 400. For instance, the system can be a distributed system (e.g., client server, multi-tier system) comprising multiple general-purpose computer systems. In one example, the system includes software processes executing on a system associated with evaluating a subject having multiple sclerosis (MS), or at risk of developing MS according to various embodiments of the invention. Various system embodiments can execute operations such as administering an assessment of processes involved in neurological and ambulatory function (e.g., EDSS); lower extremity ambulatory function (e.g., Timed Walk of 25 Feet (T25FW)); or upper extremity ambulatory function (e.g., 9 Hole Peg Test (9HP), or any combination of one, two, three, or more of the tests, as examples. The systems may permit physicians to access and manage such testing, specific patient information, patient responses, patient profiles, patient analysis, etc. There can be other computer systems that perform functions such as evaluating additional parameters chosen from one or more of quality of life, neuropsychological evaluation, or memory function, where the system can administer and/or facilitate administration of testing to establish one or more of quality of life, neuropsychological evaluation, or memory function parameters, evaluate submitted additional parameters, establish reference values from a healthy subject or an average of healthy subjects, a subject at different time interval, e.g., prior to, during, or after the MS therapy, a group of MS patients having the same or different disease progressions, calculate a disease progression value for a subject from an average value of one, two, three, or more of:

(i) an assessment of neurological and/or ambulatory function (e.g., EDSS),

(ii) an assessment of short distance ambulatory function (e.g., T25FW), or

(iii) an assessment of upper extremity function (e.g., 9HP test); and, determining a reliability of a disease progression value, determining the reliability of the disease progression value to be at least one of 0.65, 0.69, 0.70, 0.75, 0.80, 0.85, and higher.

These systems can also be configured to manage administration of testing, accept as input results from testing, determine trends in evaluations, establish a statistical confidence measure based on input results, among other options. These systems can be distributed among a communication system such as the Internet. One such distributed network, as discussed below with respect to FIG. 8, can be used to implement various aspects of the invention.

FIG. 8 shows an architecture diagram of an example distributed system 600 suitable for implementing various aspects of the invention. It should be appreciated that FIG. 8 is used for illustration purposes only, and that other architectures can be used to facilitate one or more aspects of the invention. System 600 may include one or more general-purpose computer systems distributed among a network 602 such as, for example, the Internet. Such systems may cooperate to perform functions related to evaluating a subject having multiple sclerosis (MS), or at risk of developing MS, treating a subject a subject having multiple sclerosis (MS), or a risk of developing MS, monitoring a subject having multiple sclerosis (MS), or at risk of developing MS, diagnosing or prognosing a subject having multiple sclerosis (MS), or at risk of developing MS, preventing MS in a subject having multiple sclerosis (MS), or at risk of developing MS, among other functions. Other functions executed can include functions to calculate a qualitative value for assessing MS progression, provide a user interface for inputting functional system scores according to a defined scoring system (e.g., EDSS), evaluating input scores for consistency, constraining inputs to allowed values, displaying categories for evaluating patient ambulation, limiting selection to a single option with the displayed categories, evaluating ambulation selection for consistency against functional system scores, provide for evaluation of non-calculated scores (e.g., evaluating underlying data against scoring rules to determine proper result).

In an example of one such system, one or more users operate one or more client computer systems 604, 606, and 608 through which, for example, subjects can be administered a visual, audio, or other type of test to facilitate scoring of various factors, or users can enter testing results for subject, view reports on diagnosis and/or evaluation of treatment, view suggestions on alternative therapies, etc. In another example, evaluators (e.g., physicians, clinicians, researchers, medical personnel) can access user interfaces through one or more client computer systems to enter evaluations of scoring criteria. The physicians can receive real-time feedback on scores being entered, including, for example, reminder displays regarding conversion of input values, scoring criteria and evaluations, among other options. It should be understood that the one or more client computer systems 604, 606, and 608 can also be used to access and/or update, for example, subject information, test results, potential therapies, etc. In one example, users interface with the system via an Internet-based user interface.

In another example, a system 604 includes a browser program such as the Microsoft Internet Explorer application program, Mozilla's FireFox, or Google's Chrome browser through which one or more websites can be accessed. Further, there can be one or more application programs that are executed on system 604 that perform functions associated with evaluating (including, for example, scoring) a subject having multiple sclerosis (MS), or at risk of developing MS and treating, diagnosis, and/or monitoring the subject according to various embodiments of the invention. For example, system 604 may include one or more local databases for storing, caching and/or retrieving subject information associated with testing, treating, monitoring, diagnosing MS, etc.

Network 602 may also include, one or more server systems, which can be implemented on general-purpose computers that cooperate to perform various functions including evaluating testing results, inputting testing results, determining disease progression values for a subject, evaluating treatment options based on disease progression values, suggesting alternative therapies for a subject based on disease progression values, among other functions. System 600 may execute any number of software programs or processes and the invention is not limited to any particular type or number of processes. Such processes can perform the various workflows and operations discussed, and can also include, for example, operations for generating reports regarding determinations of one or more disease progression values, communicating analysis of established values of the disease progression value, communicating evaluation or treatment of a subject to a report-receiving party or entity (e.g., a patient, a health care provider, a diagnostic provider, and/or a regulatory agency, e.g., the FDA), acquiring and storing values of a disease progression value including an assessment of upper and/or lower extremity function, in a subject (e.g., a patient, a patient group or a patient population), having multiple sclerosis (MS), or at risk for developing MS, prior to, during, and/or after the MS therapy, establishing and storing values of a disease progression value including an assessment of upper and/or lower extremity function, in a subject (e.g., a patient, a patient group or a patient population), having multiple sclerosis (MS), or at risk for developing MS, prior to, during, and/or after the MS therapy from input data and/or data received from other systems, among other examples.

### INCORPORATION BY REFERENCE

The contents of all references, figures, sequence listing, patents and published patent applications cited throughout this application are hereby incorporated by reference. All publications, patents, and patent applications mentioned herein are hereby incorporated by reference in their entirety as if each individual publication, patent or patent application was specifically and individually indicated to be incorporated by reference.

Also incorporated by reference in their entirety are any polynucleotide and polypeptide sequences which reference an accession number correlating to an entry in a public database, such as those maintained by The Institute for Genomic Research (TIGR) on the worldwide web at tigr.org and/or the National Center for Biotechnology Information (NCBI) on the worldwide web at ncbi.nlm.nih.gov.

### EQUIVALENTS

Those skilled in the art will recognize, or be able to ascertain using no more than routine experimentation, many equivalents to the specific embodiments of the invention described herein. Such equivalents are intended to be encompassed.

What is claimed is:

1. A method of treating or preventing a progressive form of multiple sclerosis (MS) in a subject, comprising:
acquiring a value of disease progression that comprises a measure of one or more of: upper extremity function, lower extremity function, and/or a measure of ambulatory function other than the Expanded Disability Status Scale (EDSS)), and
responsive to a determination of the value of disease progression, performing one, two, three, four or more of:
identifying the subject as a progressor or non-progressor of the disability;
administering an MS therapy;
selecting or altering a dosing of an MS therapy;
selecting or altering the schedule or time course of an MS therapy; or
selecting an alternative MS therapy,
thereby treating or preventing MS in the subject.

2. A method of evaluating a subject having, or at risk of having, a progressive form of MS, comprising:
acquiring a value of disease progression that comprises a measure of one or more of: upper extremity function, lower extremity function, and/or a measure of ambulatory function other than EDSS,
thereby evaluating the subject.

3. A method of evaluating or monitoring the effectiveness of a therapy in a subject having a progressive form of MS, comprising:
acquiring a value of disease progression that comprises a measure of one or more of: upper extremity function, lower extremity function, and/or a measure of ambulatory function other than EDSS,
thereby evaluating or monitoring the effectiveness of the therapy in the subject.

4. The method of any of claims 1-3, wherein the value of disease progression comprises one or both of:
(i) a measure of upper extremity function; and/or
(ii) a measure of lower extremity and/or ambulatory function, wherein:
an increase in the value of disease progression of at least 10%, 15%, 20%, 25% or more in one or both of (i)-(ii) is indicative of a steady worsening of symptoms and/or disability in the subject; and
a decrease in the value of disease progression of at least 10%, 15%, 20%, 25% or more in one or both of (i)-(ii) is indicative of an improved outcome in the subject.

5. The method of claim 4, wherein the measure of upper extremity function comprises a 9 Hole Peg Test (9HP test).

6. The method of claim 4-5, wherein the measure of lower extremity and/or ambulatory function comprises a test for short or longer distance ambulatory function, or both.

7. The method of claim 6, wherein said test for short distance ambulatory function comprises a Timed Walk of 25 Feet test (T25FW test).

8. The method of claim 6-7, wherein said test for longer distance ambulatory function comprises a 6-minute walk test (6MWT).

9. The method of any of claims 1-8, wherein the value of disease progression comprises a measure of 9HP test, a T25FW test and a 6MWT.

10. The method of any of claims 1-9, wherein the value of disease progression further comprises an evaluation of the subject's status on the EDSS.

11. The method of any of claims 1-10, which further comprises one or more of the following:
(i) identifying the subject as being in need of a first MS therapy, or an additional or alternative MS therapy;
(ii) identifying the subject as having an increased or a decreased response to a first MS therapy, or a second or alternative MS therapy;
(iii) identifying the subject as being stable or showing an improvement in one or more abilities or function, or showing a decline in one or more abilities or function;
(iv) diagnosing and/or prognosing the subject;
(v) selecting or altering the course of, an MS therapy, a dose, a treatment schedule or time course, and/or the use of an alternative MS therapy;
(vi) determining MS disease progression in the subject;
(vii) administering a first MS therapy, or an additional or alternative MS therapy to the subject; and/or
(viii) evaluating the effectiveness of a therapy in treating or preventing a progressive form of MS,
wherein a change in the disease progression value relative to a specified or reference parameter indicates one or more of: identifies the subject as being in need of the first MS therapy, or an additional or alternative MS therapy; identifies the subject as having an increased or decreased response to the therapy; determines the treatment to be used; and/or determines or predicts the time course of the onset and/or progression of MS.

12. The method of any of claims 1-11, wherein the disease progression in the MS subject comprises a steady worsening of symptoms and/or disability over time.

13. The method of any of claims 1-12, wherein the subject has primary or secondary progressive multiple sclerosis (PPMS or SPMS, respectively), or the subject has progressive-relapsing MS (PRMS).

14. The method of any of claims 1-13, wherein a confirmed increase in the disease progression value, relative to a baseline or prior value for the subject, or an average or median value for a patient population, is indicative of disease progression in the subject.

15. The method of any of claims 1-13, wherein a confirmed decrease in the disease progression value, relative to a baseline or prior value for the subject, or an average or median value for a patient population, is indicative of an improved outcome in the subject.

16. The method of any of claims 1-15, wherein the disease progression value is acquired by evaluating the following:
(i) an EDSS assessment,
(ii) an assessment of lower extremity and/or ambulatory function, and
(iii) an assessment of upper extremity function.

17. The method of claim 16, wherein a confirmed increase in the value of disease progression by at least 10%, 15%, 20%, 25% or higher in a measure of upper or lower extremity function, or ambulatory function other than EDSS, is indicative of disease progression in the subject.

18. The method of any of claims 1-16, wherein a confirmed decrease in the value of disease progression by at least 10%, 15%, 20%, 25% or more in a measure of upper or lower extremity function, or ambulatory function other than EDSS, is indicative of improved outcome in the subject.

19. The method of any of claims 16-18, wherein one or both of:
(i) an increase in EDSS total score of at least 1 point, if the change in EDSS total score is determined by evaluating one or more changes in neurological systems; and/or
(ii) an increase in the EDSS total score of at least 0.5 point if the change in EDSS total score is determined by a change in ambulatory function;
is/are indicative of disease progression in the subject.

20. The method of any of claims 16-19, wherein one, two, three or all of the following are indicative of disease progression in the subject:
(i) an EDSS total score increase of at least 1 point, if the change in EDSS total score is determined by evaluating one or more changes in neurological systems;
(ii) an EDSS total score increase of at least 0.5 point, if the change in EDSS total score is determined by a change in ambulatory function;
(iii) an increase by at least 15% or 20% in a measure of ambulatory function other than EDSS; or
(iv) an increase by at least 15% or 20% in a measure of upper or lower extremity function.

21. The method of any of claims 1-20, wherein the value of disease progression is acquired at least three, four, five or six months apart.

22. The method of any of claims 2-21, wherein said method further comprises treating, or preventing in, the subject having multiple sclerosis MS one or more symptoms associated with MS by administering to a subject an MS therapy, in an amount sufficient to reduce one or more symptoms associated with MS.

23. The method of claim 1 or 22, wherein said treating or preventing comprises reducing, retarding or preventing, a relapse, or the worsening of a disability, in the MS subject.

24. The method of any of claim 1 or 22-23, wherein the MS therapy comprises one or more of an IFN-β 1 molecule; a polymer of glutamic acid, lysine, alanine and tyrosine; an antibody or fragment thereof against alpha-4 integrin; an anthracenedione molecule; a fingolimod; a dimethyl fumarate; an antibody to the alpha subunit of the IL-2 receptor of T cells; an antibody against CD52 or alemtuzumab; an inhibitor of a dihydroorotate dehydrogenase or teriflunomide; or an anti-LINGO-1 antibody.

25. The method of claim 24, wherein the IFN-β 1 molecule comprises one or more of an IFN-β1a or IFN-β 1-b polypeptide, a variant, a homologue, a fragment or a pegylated variant thereof.

26. The method of any of claim 1 or 22-23, wherein the MS therapy comprises a first therapy chosen from one or more of:
(i) an IFNβ molecule or a pegylated variant thereof;
(ii) a polymer of glutamic acid, lysine, alanine and tyrosine;
(iii) a fingolimod or other S1P1 agonists; or
(iv) an oral dimethyl fumarate.

27. The method of claim 26, wherein a second or an alternative therapy is administered when a patient is less responsive or shows disease progression when treated with the first therapy.

28. The method of claim 27, the second or alternative therapy is chosen from one or more of an antibody or fragment thereof against alpha-4 integrin; an anthracenedione molecule; an antibody against CD52; an antibody to the alpha subunit of the IL-2 receptor of T cells; or an anti-LINGO-1 antibody.

29. The method of any of claims 1-28, further comprising one or more steps of: performing a neurological examination, performing a cognitive evaluation, or detecting the subject's lesion status as assessed using an MRI.

30. The method of any of claims 1-29, further comprising memorializing the value of disease progression, and/or providing a report comprising the memorialization.

31. A method for generating a report, comprising:
acquiring a value of disease progression comprising one or more of:
a measure of upper extremity function;
a measure of lower extremity function; and/or
a measure of ambulatory function other than EDSS,
in a subject having a progressive form of MS, or at risk for developing MS, prior to, during, and/or after the MS therapy; and
memorializing the value in the report.

32. The method of claim 31, further comprising:
acquiring a value of disease progression that comprises an EDSS assessment.

33. A system for evaluating a subject, comprising at least one processor operatively connected to a memory, the at least one processor when executing is configured to:
determine or calculate a value of disease progression associated with the subject, wherein the processor is further configured to calculate the value of the disease progression value responsive to establishing for the subject one or more of:
a measure of upper extremity function;
a measure of lower extremity function; and/or
a measure of ambulatory function other than EDSS; and
evaluate the subject, based on at least one value of the disease progression value established prior to, during, or after the conclusion of, an MS therapy, or established responsive to administration of an MS therapy.

34. The system of claim 33, further comprising:
acquiring a value of disease progression that comprises an EDSS assessment.

35. A kit for evaluating an MS patient, comprising:
a means or tests for evaluating one, two, or three factors chosen from one or more of:
(i) an assessment of short distance ambulatory function,
(ii) an assessment of longer distance ambulatory function other than EDSS, or
(iii) an assessment of upper extremity function, and
a means for determining a value of disease progression associated with the subject, prior to, during, and/or after an MS therapy.

36. The kit of claim 35, further comprising evaluating an EDSS assessment.

37. A system for establishing a quantitative value for assessing MS disease status or progression, the system comprising:
at least one processor operatively connected to a memory;
a scoring component, executed by the at least one processor, configured to execute scoring rules;
a rules object accessible by the scoring component defining a plurality of scoring rules for combining assessment values;
a user interface, executed by the at least one processor, configured to display selection criteria for evaluating ambulation of a patient, wherein the user interface is configured to accept for scoring a single selected category within a plurality of displayed ambulation categories;
wherein the scoring component is configured to:
identify a plurality of scoring rules associated with the selected category for combining a plurality of scores for patient functionality, and
generate the quantitative value for MS disease status or progression responsive to execution of the plurality of scoring rules.

38. The system according to claim 37, wherein the user interface is configured to accept one or more EDSS functional system (FS) scores for assessing a subject.

39. The system according to claim 38, wherein the user interface is configured to accept one, two, three, four, five, six, or all seven individual scores for the EDSS FS chosen from visual, brainstem, cerebellar, motor, sensory, bladder/bowel or cognitive systems.

40. The system according to claim 38-39, wherein the scoring component combines the one or more EDSS functional system scores with an ambulation score associated with the selected category to generate the quantitative value.

41. The system according to claim 37, wherein the rules object includes a plurality of category definitions for assessing a subject's ambulation.

42. The system according to claim 41, wherein the plurality of category definitions comprise at least 4, 5, 6, 7, 8, 9, 10, 12, 13, 14, 15, 16 or more options for assessing a subject's ambulation, wherein each option is associated with an ambulation score.

43. The system according to claim 42, wherein the plurality of category definitions comprise one or more (or all) of: Unrestricted ambulation without aid or rest for a predetermined distance chosen from a distance greater or equal to 500, 300, 200, or 100 meters, or less than 200 or 100 meters; unilateral assistance; bilateral assistance; essentially or fully restricted to a wheelchair; or essentially or fully restricted to a bed.

44. The system according to claim 42, wherein the plurality of category definitions comprise one or more of: one to six categories for assessing ambulation without aid or rest, one or two categories for assessing ambulation with unilateral assistance, one or two categories for assessing ambulation with bilateral assistance, or one to six categories for assessing restricted ambulation.

45. The system according to claim 37, further comprising an evaluation component, executed by the at least one processor, configured to evaluate a user-entered quantitative value for MS disease status or progression.

46. The system according to claim 45, wherein the evaluation component is configured to determine that a user-entered quantitative value is inconsistent with a corresponding calculated value.

47. The system according to claim 38, wherein the user interface is configured to constrain one or more input EDSS functional system scores to a valid value.

48. The system according to claim 47, wherein the user interface is configured to display a notification regarding a likely error responsive to user accessing data input fields.

49. The system according to claim 48, wherein the user interface is configured to display a notification regarding a converted score for a visual or bowel/bladder functional system scores, or both.

50. The system according to claim 38, wherein the user interface is configured to evaluate an input value to determine consistency with a scoring rule in real time.

51. The system according to claim 37, further comprising an administration component configured to update the rules object.

52. The system according to claim 51, wherein the administration component is configured to define at least one active rule for execution.

53. The system according to claim 52, wherein the administration component is configured to mark an existing rule as an inactive rule, wherein the inactive rule is not executed for establishing the quantitative value for assessing MS disease status or progression.

54. The system according to claim 51, wherein defining the at least one active rule for execution includes at least one or updating an existing scoring rule and creating a new scoring rule responsive to a change in approved scoring criteria.

55. The system according to claim 37, further comprising a pre-qualification component configured to evaluate a pre-treatment scoring of an individual subject.

56. The system according to claim 55, wherein the pre-qualification component is configured to identify a candidate with a pre-treatment score within a pre-defined threshold.

57. The system according to claim 55, wherein the pre-qualification component is configured to identify a candidate with a pre-treatment score exceeding a pre-defined threshold.

58. The system according to claims 56-57, wherein the pre-qualification component is configured to define a candidate population for inclusion in a clinical trial responsive to evaluation of the pre-defined threshold.
